(19) United States
(12) Patent Application Publication
(10) Pub. No.: US 2026/0101347 A1
(43) Pub. Date: Apr. 9, 2026

(54) UPLINK MESSAGE REPETITIONS FOR SUBBAND FULL DUPLEX-AWARE DEVICES

(71) Applicant: QUALCOMM Incorporated, San Diego, CA (US)

(72) Inventors: Abdelrahman Mohamed IBRAHIM, San Diego, CA (US); Muhammad Sayed Khairy ABDELGHAFFAR, San Jose, CA (US)

(21) Appl. No.: 19/329,371

(22) Filed: Sep. 15, 2025

Related U.S. Application Data
(60) Provisional application No. 63/703,175, filed on Oct. 3, 2024.

(51) Int. Cl. H04W 72/21; H04L 5/14; H04W 72/0446; H04W 74/0833

(52) U.S. Cl. CPC H04W 72/21; H04W 72/0446; H04W 74/0833; H04L 5/14

(57) ABSTRACT

Methods, systems, and devices for wireless communications are described. A user equipment (UE) may receive control signaling indicating a first set of uplink occasions corresponding to a first type of uplink occasions, and a second set of uplink occasions corresponding to a second type of uplink occasions, where the first type of uplink occasions are subband full duplex (SBFD) uplink occasions, and the second type of uplink occasions are non-SBFD occasions. The UE may receive second control signaling indicating a first configuration supporting wireless communications via the first type of symbols or the second type of symbols, or a second configuration supporting wireless communications via both the first and second types of symbols. The UE may perform resource selection of uplink occasions for uplink repetitions, and may transmit one or more repetitions of an uplink message via the selected one or more uplink occasions.

### CROSS REFERENCE

The present application for patent claims the benefit of U.S. Provisional Patent Application No. 63/703,175 by IBRAHIM et al., entitled “UPLINK MESSAGE REPETITIONS FOR 2-STEP RACH PROCEDURE,” filed Oct. 3, 2024, assigned to the assignee hereof, and expressly incorporated by reference herein.

### FIELD OF TECHNOLOGY

The following relates to wireless communications, including uplink message repetitions for subband full duplex (SBFD)-aware devices.

### BACKGROUND

Wireless communications systems are widely deployed to provide various types of communication content such as voice, video, packet data, messaging, broadcast, and so on. These systems may be capable of supporting communication with multiple users by sharing the available system resources (such as, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first control signaling indicating a first set of uplink occasions corresponding to a first type of uplink occasions, and a second set of uplink occasions corresponding to a second type of uplink occasions, where the first type of uplink occasions corresponds to a first type of symbols supporting a subband full duplex (SBFD) mode of operation, and the second type of uplink occasions corresponds to a second type of symbols supporting a half duplex mode of operation, receiving second control signaling indicating a first configuration or a second configuration, where the first configuration supports wireless communications via the first type of symbols or the second type of symbols, and where the second configuration supports wireless communications via both the first type of symbols and the second type of symbols, and transmitting one or more repetitions of an uplink message via one or more uplink occasions of the first set of uplink occasions, via one or more uplink occasions of the second set of uplink occasions, or both, where the one or more uplink occasions of the first set of uplink occasions, the one or more uplink occasions of the second set of uplink occasions, or both are selected in accordance with a slot counting procedure in which one or more slots are counted, where the slot counting procedure is based on the first configuration or the second configuration.

A UE for wireless communications is described. The UE may include one or more memories storing processor executable code, and one or more processors coupled with the one or more memories. The one or more processors may individually or collectively be operable to execute the code to cause the UE to receive first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation, receive second control signaling indicating a first configuration or a second configuration, where the first configuration supports wireless communications via the first type of symbols or the second type of symbols, and where the second configuration supports wireless communications via both the first type of symbols and the second type of symbols, and transmit one or more repetitions of an uplink message via one or more uplink occasions of the first set of uplink occasions, via one or more uplink occasions of the second set of uplink occasions, or both, where the one or more uplink occasions of the first set of uplink occasions, the one or more uplink occasions of the second set of uplink occasions, or both are selected in accordance with a slot counting procedure in which one or more slots are counted, where the slot counting procedure is based on the first configuration or the second configuration.

Another UE for wireless communications is described. The UE may include means for receiving first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation, means for receiving second control signaling indicating a first configuration or a second configuration, where the first configuration supports wireless communications via the first type of symbols or the second type of symbols, and where the second configuration supports wireless communications via both the first type of symbols and the second type of symbols, and means for transmitting one or more repetitions of an uplink message via one or more uplink occasions of the first set of uplink occasions, via one or more uplink occasions of the second set of uplink occasions, or both, where the one or more uplink occasions of the first set of uplink occasions, the one or more uplink occasions of the second set of uplink occasions, or both are selected in accordance with a slot counting procedure in which one or more slots are counted, where the slot counting procedure is based on the first configuration or the second configuration.

A non-transitory computer-readable medium storing code for wireless communications is described. The code may include instructions executable by one or more processors to receive first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation, receive second control signaling indicating a first configuration or a second configuration, where the first configuration supports wireless communications via the first type of symbols or the second type of symbols, and where the second configuration supports wireless communications via both the first type of symbols and the second type of symbols, and transmit one or more repetitions of an uplink message via one or more uplink occasions of the first set of uplink occasions, via one or more uplink occasions of the second set of uplink occasions, or both, where the one or more uplink occasions of the first set of uplink occasions, the one or more uplink occasions of the second set of uplink occasions, or both are selected in accordance with a slot counting procedure in which one or more slots are counted, where the slot counting procedure is based on the first configuration or the second configuration.

In some examples of the method, user equipment (UEs), and non-transitory computer-readable medium described herein, receiving the second control signaling may include operations, features, means, or instructions for receiving a feature combination message indicating support of repetitions of the uplink message, and indicating a first subset of random access resources of a set of multiple candidate random access resources, the first subset of random access resources corresponding to the supported repetitions of the uplink message, where the one or more repetitions of the uplink message are transmitted based on receiving the feature combination message.

In some examples of the method, user equipment (UEs), and non-transitory computer-readable medium described herein, the feature combination message indicates that repetition of the uplink message may be supported via the first type of symbols or the second type of symbols in accordance with the first configuration.

In some examples of the method, user equipment (UEs), and non-transitory computer-readable medium described herein, the feature combination message indicates that repetitions of the uplink message may be supported via both the first type of symbols and the second type of symbols in accordance with the second configuration.

Some examples of the method, user equipment (UEs), and non-transitory computer-readable medium described herein may further include operations, features, means, or instructions for transmitting a random access preamble via a random access resource of the first subset of random access resources, the random access preamble transmitted via the random access resource indicating that the UE supports repetitions of the uplink message via the second type of symbols or the first type of symbols in accordance with the first configuration, or via both the first type of symbols and the second type of symbols in accordance with the second configuration, where the one or more repetitions of the uplink message are transmitted based on transmitting the random access preamble.

Some examples of the method, user equipment (UEs), and non-transitory computer-readable medium described herein may further include operations, features, means, or instructions for receiving a random access message triggering the uplink message and selecting a first uplink occasion of the one or more uplink occasions of the first set of uplink occasions, the one or more uplink occasions of the second set of uplink occasions, or both based on a validity of one or more symbols of the first uplink occasion and in accordance with the slot counting procedure, where the validity of the one or more symbols may be based on an indication in the random access message, a reference slot type indicated via the second control signaling, a symbol type corresponding to the symbol via which the random access message may be received, or any combination thereof.

Some examples of the method, user equipment (UEs), and non-transitory computer-readable medium described herein may further include operations, features, means, or instructions for receiving a random access message triggering the uplink message and selecting a first uplink occasion of the one or more uplink occasions of the first set of uplink occasions, the one or more uplink occasions of the second set of uplink occasions, or both based on a validity of one or more symbols of the first uplink occasion and in accordance with the slot counting procedure, the first uplink occasion occurring in a slot that includes a first subset of the first type of symbols and a second subset of the second type of symbols, where the validity of the one or more symbols may be based on a time domain resource allocation in the random access message, a symbol type of a first in time symbol of the slot, a default type of symbol including the second type of symbol, or any combination thereof.

Some examples of the method, user equipment (UEs), and non-transitory computer-readable medium described herein may further include operations, features, means, or instructions for receiving a control message indicating a quantity of the one or more repetitions for the uplink message and selecting the one or more uplink occasions of the first set of uplink occasions, the one or more uplink occasions of the second set of uplink occasions, or both according to the slot counting procedure from slots that include the first type of symbols and do not include the second type of symbols in accordance with the control message and the first configuration.

Some examples of the method, user equipment (UEs), and non-transitory computer-readable medium described herein may further include operations, features, means, or instructions for receiving a control message indicating a quantity of the one or more repetitions for the uplink message and a slot offset value indicating a reference slot for a first uplink occasion of the one or more uplink occasions and selecting the one or more uplink occasions of the first set of uplink occasions, the one or more uplink occasions of the second set of uplink occasions, or both based on a physical slot counting procedure, the first uplink occasion of the one or more uplink occasions of the first set of uplink occasions, the second set of uplink occasions, or both located in the reference slot indicated by the slot offset value.

Some examples of the method, user equipment (UEs), and non-transitory computer-readable medium described herein may further include operations, features, means, or instructions for selecting the one or more uplink occasions of the first set of uplink occasions, the one or more uplink occasions of the second set of uplink occasions, or both in accordance with the first configuration and a validity of a set of multiple slots and refraining from selecting one or more additional uplink occasions according to the slot counting procedure in response to the one or more additional uplink occasions including the first type of uplink occasion, or in response a slot including an uplink occasion further including one or more symbols overlapping in time with a synchronization signal block.

Some examples of the method, user equipment (UEs), and non-transitory computer-readable medium described herein may further include operations, features, means, or instructions for selecting the one or more uplink occasions of the first set of uplink occasions, the one or more uplink occasions of the second set of uplink occasions, or both in accordance with the first configuration and a validity of a set of multiple slots and refraining from selecting one or more additional uplink occasions according to the slot counting procedure in response the one or more additional uplink occasions including the second type of uplink occasion, in response to a slot corresponding to an uplink occasion including both the first type of symbol and the second type of symbol, or in response to the slot corresponding to the uplink occasion including one or more symbols overlapping in time with a synchronization signal block.

Some examples of the method, user equipment (UEs), and non-transitory computer-readable medium described herein may further include operations, features, means, or instructions for selecting the one or more uplink occasions of the first set of uplink occasions, the one or more uplink occasions of the second set of uplink occasions, or both in accordance with the second configuration and a validity of a set of multiple slots according to the slot counting procedure and refraining from selecting one or more additional uplink occasions according to the slot counting procedure in response to the one or more additional uplink occasions being located within downlink slots, or in response to an uplink occasion being located within a slot that includes both the first type of symbols and the second type of symbols, or in response to the slot corresponding to the uplink occasion including one or more symbols overlapping in time with a synchronization signal block.

In some examples of the method, user equipment (UEs), and non-transitory computer-readable medium described herein, receiving the second control signaling may include operations, features, means, or instructions for receiving system information including a feature combination information element including an indication of the first configuration or the second configuration.

In some examples of the method, user equipment (UEs), and non-transitory computer-readable medium described herein, receiving the second control signaling may include operations, features, means, or instructions for receiving a random access response message including a media access control (MAC) control element (CE), the MAC-CE indicating the first configuration or the second configuration.

In some examples of the method, user equipment (UEs), and non-transitory computer-readable medium described herein, receiving the second control signaling may include operations, features, means, or instructions for receiving a downlink control information message, a field in the downlink control information message including an indication of the first configuration or the second configuration.

Some examples of the method, user equipment (UEs), and non-transitory computer-readable medium described herein may further include operations, features, means, or instructions for receiving a downlink control information message triggering transmission of the uplink message, the downlink control information message including a frequency hopping offset for repetitions of the uplink message, where transmitting the one or more repetitions of the uplink message may be in accordance with the frequency hopping offset, and where the frequency hopping offset may be based on a subband corresponding to the uplink message and the one or more uplink occasions.

In some examples of the method, user equipment (UEs), and non-transitory computer-readable medium described herein, the one or more repetitions of the uplink message include one or more repetitions of a random access message.

A method for wireless communications by a network entity is described. The method may include transmitting first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation, transmitting second control signaling indicating a first configuration or a second configuration, where the first configuration supports wireless communications via the first type of symbols or the second type of symbols, and where the second configuration supports wireless communications via both the first type of symbols and the second type of symbols, and receiving one or more repetitions of an uplink message via one or more uplink occasions of the first set of uplink occasions, via one or more uplink occasions of the second set of uplink occasions, or both, where the one or more uplink occasions of the first set of uplink occasions, the one or more uplink occasions of the second set of uplink occasions, or both are based on a slot counting procedure in which one or more slots are counted, where the slot counting procedure is based on the first configuration or the second configuration.

A network entity for wireless communications is described. The network entity may include one or more memories storing processor executable code, and one or more processors coupled with the one or more memories. The one or more processors may individually or collectively be operable to execute the code to cause the network entity to transmit first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation, transmit second control signaling indicating a first configuration or a second configuration, where the first configuration supports wireless communications via the first type of symbols or the second type of symbols, and where the second configuration supports wireless communications via both the first type of symbols and the second type of symbols, and receive one or more repetitions of an uplink message via one or more uplink occasions of the first set of uplink occasions, the second set of uplink occasions, or both, where the one or more uplink occasions are based on a slot counting procedure in which one or more slots are counted, where the slot counting procedure is based on the first configuration or the second configuration.

Another network entity for wireless communications is described. The network entity may include means for transmitting first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation, means for transmitting second control signaling indicating a first configuration or a second configuration, where the first configuration supports wireless communications via the first type of symbols or the second type of symbols, and where the second configuration supports wireless communications via both the first type of symbols and the second type of symbols, and receiving one or more repetitions of an uplink message via one or more uplink occasions of the first set of uplink occasions, via one or more uplink occasions of the second set of uplink occasions, or both, where the one or more uplink occasions of the first set of uplink occasions, the one or more uplink occasions of the second set of uplink occasions, or both are based on a slot counting procedure in which one or more slots are counted, where the slot counting procedure is based on the first configuration or the second configuration.

A non-transitory computer-readable medium storing code for wireless communications is described. The code may include instructions executable by one or more processors to transmit first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation, transmit second control signaling indicating a first configuration or a second configuration, where the first configuration supports wireless communications via the first type of symbols or the second type of symbols, and where the second configuration supports wireless communications via both the first type of symbols and the second type of symbols, and receive one or more repetitions of an uplink message via one or more uplink occasions of the first set of uplink occasions, the second set of uplink occasions, or both, where the one or more uplink occasions are based on a slot counting procedure in which one or more slots are counted, where the slot counting procedure is based on the first configuration or the second configuration.

In some examples of the method, network entities, and non-transitory computer-readable medium described herein, transmitting the second control signaling may include operations, features, means, or instructions for transmitting a feature combination message indicating support of repetitions of the uplink message, and indicating a first subset of random access resources of a set of multiple candidate random access resources, the first subset of random access resources corresponding to the supported repetitions of the uplink message, where receiving the one or more repetitions of the uplink message may be based on transmitting the feature combination message.

In some examples of the method, network entities, and non-transitory computer-readable medium described herein, the feature combination message indicates that repetition of the uplink message may be supported via the first type of symbols or the second type of symbols in accordance with the first configuration.

In some examples of the method, network entities, and non-transitory computer-readable medium described herein, the feature combination message indicates that repetitions of the uplink message may be supported via both the first type of symbols and the second type of symbols in accordance with the second configuration.

Some examples of the method, network entities, and non-transitory computer-readable medium described herein may further include operations, features, means, or instructions for receiving a random access preamble via a random access resource of the first subset of random access resources, the random access preamble received via the random access resource indicating that the UE supports repetitions of the uplink message via the second type of symbols or the first type of symbols in accordance with the first configuration, or via both the first type of symbols and the second type of symbols in accordance with the second configuration, where receiving the one or more repetitions of the uplink message may be based on receiving the random access preamble.

In some examples of the method, network entities, and non-transitory computer-readable medium described herein, transmitting the second control signaling may include operations, features, means, or instructions for transmitting system information including a feature combination information element including an indication of the first configuration or the second configuration.

In some examples of the method, network entities, and non-transitory computer-readable medium described herein, transmitting the second control signaling may include operations, features, means, or instructions for transmitting a random access response message including a MAC control element (CE), the MAC-CE indicating the first configuration or the second configuration.

In some examples of the method, network entities, and non-transitory computer-readable medium described herein, transmitting the second control signaling may include operations, features, means, or instructions for transmitting a downlink control information message, a field in the downlink control information message including an indication of the first configuration or the second configuration.

Some examples of the method, network entities, and non-transitory computer-readable medium described herein may further include operations, features, means, or instructions for transmitting a downlink control information message triggering transmission of the uplink message, the downlink control information message including a frequency hopping offset for repetitions of the uplink message, where receiving the one or more repetitions of the uplink message may be in accordance with the frequency hopping offset, and where the frequency hopping offset may be based on a subband corresponding to the uplink message and the one or more uplink occasions.

In some examples of the method, network entities, and non-transitory computer-readable medium described herein, the one or more repetitions of the uplink message include one or more repetitions of a random access message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports uplink message repetitions for subband full duplex (SBFD)-aware devices.

FIG. 2 shows an example of a wireless communications system that supports uplink message repetitions for SBFD-aware devices and uplink occasion selection according to one of multiple candidate configurations.

FIG. 3 shows an example of a resource configuration scheme that supports uplink message repetitions for SBFD-aware devices and a configuration indicating that one of SBFD symbols or non-SBFD resources are valid for uplink repetitions, or a configuration indicating that both SBFD symbols and non-SBFD symbols are valid.

FIG. 4 shows an example of a process flow that supports uplink message repetitions for SBFD-aware devices and uplink occasion selection according to one of multiple candidate configurations.

FIG. 5 shows an example of a frequency hopping scheme that supports different starting resource blocks for frequency hopping in uplink message repetitions for SBFD-aware devices.

FIGS. 6 and 7 show block diagrams of devices that support uplink message repetitions for SBFD-aware devices.

FIG. 8 shows a block diagram of a communications manager that supports uplink message repetitions for SBFD-aware devices.

FIG. 9 shows a diagram of a system including a device that supports uplink message repetitions for SBFD-aware devices.

FIGS. 10 and 11 show block diagrams of devices that support uplink message repetitions for SBFD-aware devices.

FIG. 12 shows a block diagram of a communications manager that supports uplink message repetitions for SBFD-aware devices.

FIG. 13 shows a diagram of a system including a device that supports uplink message repetitions for SBFD-aware devices.

FIGS. 14 through 17 show flowcharts illustrating methods that support uplink message repetitions for SBFD-aware devices.

### DETAILED DESCRIPTION

A wireless communications system may perform wireless signaling, and may support uplink repetitions via one or more uplink occasions. Uplink repetitions (e.g., transmitting an uplink message multiple times via multiple uplink occasions) may increase the reliability of wireless communications. A user equipment (UE) may be configured with multiple uplink occasions, and may select uplink occasions via which to transmit configured uplink repetitions (e.g., such as a random access message, or retransmission). The UE may select the available uplink occasions based on a determination of whether each of multiple slots are valid (such as, according to one or more rules, a type of slot, etc.). The wireless communications system may also support communications via subband full duplex (SBFD) slots in which both uplink and downlink subbands are available. Some slots may be SBFD slots, and other slots may be configured as non-SBFD slots (such as, uplink slots, downlink slots, or flexible slots). However, without clear rules or signaling instructing the UE, the UE and the network entity may not be aligned regarding which slots (e.g., SBFD slots) are valid, and which slots are invalid.

A UE may be configured with information that supports selection of uplink resources for uplink repetitions (e.g., uplink repetitions of an uplink message such as a message 3 of a four-step random access procedure). To support uplink transmission and downlink transmissions across SBFD symbols and non-SBFD symbols in different slots (such as, each transmission within a slot may occur via either all SBFD symbols or all non-SBFD symbols, or may occur across both types of symbols) an SBFD aware user equipment (UE)) may be provided with a configuration indicating which resources are available (such as, valid) for one or more uplink transmissions. The UE may receive control signaling which may indicate a first configuration (such as, configuration 1). According to the first configuration, transmissions and receptions may be restricted to SBFD symbols, or may be restricted to non-SBFD symbols. In some examples, the UE may receive control signaling which may indicate a second configuration (such as, configuration 2). According to the second configuration, repetitions of uplink transmissions and receptions may occur in SBFD symbols and non-SBFD symbols.

In some examples, the UE may be configured with one or more uplink occasions across various slots, which may include uplink slots (such as, or flexible slots) and SBFD slots. In such examples, without a mechanism or rule for determination, it may be unclear to the UE which uplink occasions are available or valid for repetition of uplink transmissions. For example, in the case of repetitions for an uplink message, the UE may perform an uplink counting procedure. The UE may count available slots for uplink transmissions, but if the UE and the network are not identifying resources according to the same selection rules (such as, determining the same slots to be valid or invalid), then uplink transmission may fail, throughput may decrease, available system resources may be inefficiently allocated or utilized, system latency may increase, and user experience may be negatively impacted.

Techniques described herein provide for wireless signaling and rules for uplink occasion selection (such as, slot counting) to increase the likelihood that the UE and the network entity are able to efficiently determine which resources to use for uplink repetitions. The network entity may indicate (such as, via control signaling) support of uplink repetition via one or more resources, and the UE may interpret such indications according to one or more rules or techniques described herein. For instance, the network entity may transmit an indication of supported uplink repetitions (e.g., such as message 3 repetitions in a random access procedure), and the indication may be interpreted to indicate that the uplink repetition is supported in non-SBFD symbols or in SBFD symbols (such as, according to the first configuration), or the indication of supported uplink repetitions may indicate that uplink repetitions are supported in both non-SBFD symbols and SBFD symbols (such as, according to the second configuration). In such examples, the UE may be able to determine which uplink occasions are valid for uplink repetitions, resulting in more efficient wireless communications and increased throughput due to avoidance of mismatched resource selection at the UE and the network entity. The UE may indicate, to the network entity that it is capable of uplink repetitions, and such an indication may indicate which resources will be considered valid (such as, the UE may indicate support of uplink repetitions via SBFD symbols or non-SBFD symbols according to the first configuration, or may indicate support of uplink repetitions via both SBFD symbols and non-SBFD symbols according to the second configuration). Based on the network entity indicating the support of uplink repetition and the UE interpreting such indications according to the one or more rules as described herein, the UE may be able to determine which uplink occasions are valid for uplink repetitions, resulting in more efficient wireless communications and increased throughput due to avoidance of mismatched resource selection at the UE and the network entity. The UE may indicate, to the network entity that it is capable of uplink repetitions, and such an indication may indicate which resources will be considered valid (such as, the UE may indicate support of uplink repetitions via SBFD symbols or non-SBFD symbols according to the first configuration, or may indicate support of uplink repetitions via both SBFD symbols and non-SBFD symbols according to the second configuration). By indicating that it is capable of uplink repetitions in addition to which resources will be considered valid, the UE early indication of capability may result in improved alignment and coordination between the devices and increased throughput. The UE may then determine valid slots for uplink repetitions (such as, may perform available slot counting and select uplink occasions) in accordance with the resource configuration and in accordance with the features supported by the network entity.

In some examples, as described herein, a default mode for uplink repetitions (such as, message 3 repetitions) may be based on the first configuration (such as, message 3 repetitions may be located in SBFD uplink occasions but not in non-SBFD uplink occasions). In such examples, valid symbol types (such as, symbols that can be counted as available for uplink repetitions) may be determined based on an explicitly indication in a DCI field, a reference slot type indicated in a control message such as a grant, or a slot or symbol via which the grant is received. In some examples, where under the first configuration both SBFD and non-SBFD slots are candidates for uplink repetition, a valid symbol type may be given by allocated symbol types as indicated in a time domain resource allocation (TDRA), a first symbol of a slot or resource allocation, or according to a default rule. As such, by providing an indication of valid symbol types via the first configuration, the network entity may be able to dynamically and clearly indicate which uplink occasions are available (such as, valid), and the uplink resource selection and uplink repetitions may be efficiently accomplished, resulting in more efficient use of available resources and improved throughput.

In some examples, a quantity of repetitions may be configured for SBFD repetitions, or non-SBFD repetitions, under the first configuration. In such examples, a repetition in an SBFD symbol may be based on available slot counting where valid symbols include SBFD symbols (such as, but not non-SBFD symbols). In other such examples, repetition in SBFD symbols may be based on a physical slot counting procedure with a first repetition given by a slot offset value indicated via dynamic control signaling. In such examples, by indicating the quantity of repetitions configured for SBFD repetitions, or non-SBFD repetitions via the first configuration, the network entity may be able to dynamically and clearly indicate which uplink occasions are available (such as, valid), and the uplink resource selection and uplink repetitions may be efficiently accomplished, resulting in more efficient use of available resources and improved throughput.

In some examples, when the first configuration is indicated to the UE, if a valid symbol is determined as a non-SBFD symbol, the slot may not be counted if the slot is an SBFD symbol, or if the non-SBFD symbols overlap in time with any synchronization signal blocks (SSBs). In some examples, if a valid symbol is determined as an SBFD symbol, then a slot may not be counted if the slot is a non-SBFD symbol, or if the slot is a mixed slot (such as, including both SBFD symbols and non-SBFD symbols), or if the slot is an SBFD slot but at least one symbol overlaps in time with an SSB. In some cases, the second configuration may be used for uplink repetitions, in which case both SBFD slots and non-SBFD slots may be eligible for uplink repetitions. In such examples, a slot may not be counted if the slot is a downlink slot and is not configured as an SBFD slot, or if the slot is an SBFD symbol and at least one symbol overlaps in time with an SSB, or if the slot is a mixed slot. Accordingly, such rules for interpreting which slots are available for uplink repetition may provide improved clarity in uplink occasion selection without increased signaling overhead, resulting in more efficient use of system resources and improved reliability of uplink signaling (such as or including random access signaling).

The network entity may indicate the first configuration or the second configuration to the UE via a parameter in a feature combination (such as, in a system information block (SIB), via a parameter in a media access control (MAC) control element (CE), or via a bitfield in a DCI message. The indication of the first configuration or the second configuration via such control signaling may clearly indicate to the UE which type of configuration the UE is to rely on for uplink occasion selection, which may result in more efficient resource allocation and selection, improved efficiency, more reliable wireless signaling, and improved throughput.

The network entity may schedule the UE with frequency hopping via bitfields in a grant. However, frequency hopping may be different in SBFD resources than in non-SBFD resources (such as, due to the uplink and downlink subbands in an SBFD slot). The network entity may provide parameters for frequency hopping in uplink repetition transmission, and the UE may determine frequency hopping differently in SBFD slots than in non-SBFD slots. In some examples, the UE may select initial resource blocks for transmissions based on the parameters, or may apply a modular operation to identify resources for frequency hopping that are based on a subband size (such as, instead of a bandwidth part (BWP) size) for SBFD slots. Such configuration of parameters for frequency hopping may result in effective frequency diversity in uplink repetitions even in SBFD slots, increasing the likelihood of successful transmissions, and improving throughput and efficiency.

Aspects of the disclosure are initially described in the context of wireless communications systems. Aspects of the disclosure are further illustrated by and described with reference to wireless communications systems, resource configuration schemes, process flows, and frequency hopping schemes. Aspects of the disclosure are further illustrated by and described with reference to apparatus diagrams, system diagrams, and flowcharts that relate to uplink message repetitions for SBFD-aware devices.

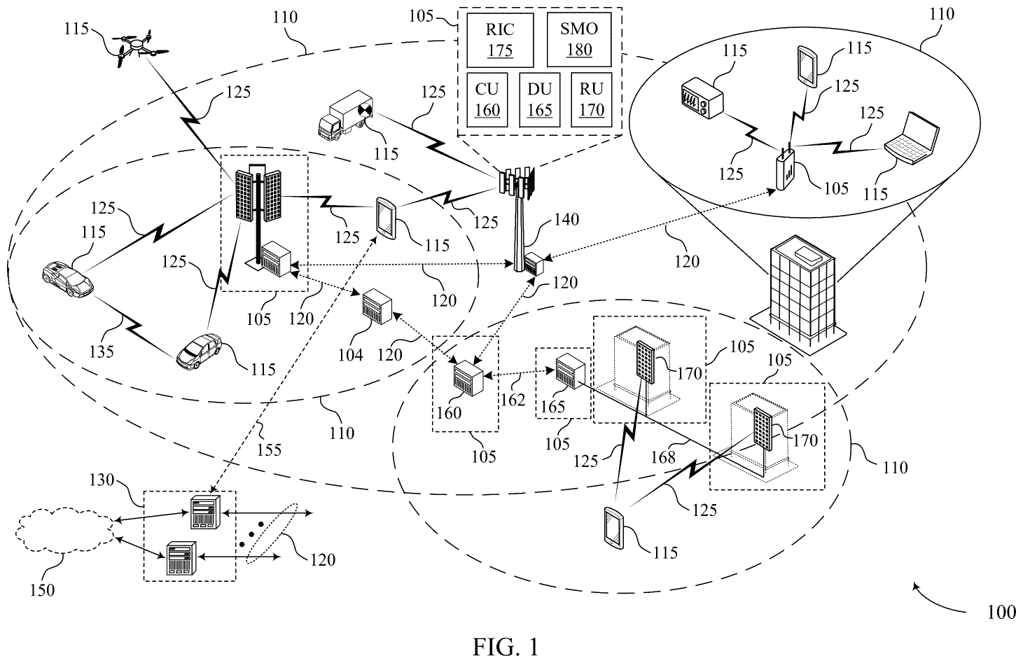

FIG. 1 shows an example of a wireless communications system 100 that supports uplink message repetitions for SBFD-aware devices. The wireless communications system 100 may include one or more devices, such as one or more network devices (such as, network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (such as, a radio frequency (RF) access link). For example, a network entity 105 may support a coverage area 110 (such as, a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (such as, other wireless communication devices, including UEs 115 or network entities 105), as shown in FIG. 1.

As described herein, a node of the wireless communications system 100, which may be referred to as a network node, or a wireless node, may be a network entity 105 (such as, any network entity described herein), a UE 115 (such as, any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (such as, in accordance with an S1, N2, N3, or other interface protocol). In some examples, network entities 105 may communicate with one another via backhaul communication link(s) 120 (such as, in accordance with an X2, Xn, or other interface protocol) either directly (such as, directly between network entities 105) or indirectly (such as, via the core network 130). In some examples, network entities 105 may communicate with one another via a midhaul communication link 162 (such as, in accordance with a midhaul interface protocol) or a fronthaul communication link 168 (such as, in accordance with a fronthaul interface protocol), or any combination thereof. The backhaul communication link(s) 120, midhaul communication links 162, or fronthaul communication links 168 may be or include one or more wired links (such as, an electrical link, an optical fiber link) or one or more wireless links (such as, a radio link, a wireless optical link), among other examples or various combinations thereof. A UE 115 may communicate with the core network 130 via a communication link 155.

One or more of the network entities 105 or network equipment described herein may include or may be referred to as a base station 140 (such as, a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (such as, a base station 140) may be implemented in an aggregated (such as, monolithic, standalone) base station architecture, which may be configured to utilize a protocol stack that is physically or logically integrated within one network entity (such as, a network entity 105 or a single RAN node, such as a base station 140).

In some examples, a network entity 105 may be implemented in a disaggregated architecture (such as, a disaggregated base station architecture, a disaggregated RAN architecture), which may be configured to utilize a protocol stack that is physically or logically distributed among multiple network entities (such as, network entities 105), such as an integrated access and backhaul (IAB) network, an open RAN (O-RAN) (such as, a network configuration sponsored by the O-RAN Alliance), or a virtualized RAN (vRAN) (such as, a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (such as, a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as, separate physical locations). In some examples, one or more of the network entities 105 of a disaggregated RAN architecture may be implemented as virtual units (such as, a virtual CU (VCU), a virtual DU (VDU), a virtual RU (VRU)).

The split of functionality between a CU 160, a DU 165, and an RU 170 is flexible and may support different functionalities depending on which functions (such as, network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (such as, layer 3 (L3), layer 2 (L2)) functionality and signaling (such as, Radio Resource Control (RRC), service data adaptation protocol (SDAP), Packet Data Convergence Protocol (PDCP)). The CU 160 (such as, one or more CUs) may be connected to a DU 165 (such as, one or more DUs) or an RU 170 (such as, one or more RUs), or some combination thereof, and the DUs 165, RUs 170, or both may host lower protocol layers, such as layer 1 (L1) (such as, physical (PHY) layer) or L2 (such as, radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as, via one or multiple different RUs, such as an RU 170). In some cases, a functional split between a CU 160 and a DU 165 or between a DU 165 and an RU 170 may be within a protocol layer (such as, some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (such as, F1, F1-c, F1-u), and a DU 165 may be connected to an RU 170 via a fronthaul communication link 168 (such as, open fronthaul (FH) interface). In some examples, a midhaul communication link 162 or a fronthaul communication link 168 may be implemented in accordance with an interface (such as, a channel) between layers of a protocol stack supported by respective network entities (such as, one or more of the network entities 105) that are in communication via such communication links.

In some wireless communications systems (such as, the wireless communications system 100), infrastructure and spectral resources for radio access may support wireless backhaul link capabilities to supplement wired backhaul connections, providing an IAB network architecture (such as, to a core network 130). In some cases, in an IAB network, one or more of the network entities 105 (such as, network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (such as, IAB donors) may be in communication with one or more additional devices (such as, IAB node(s) 104) via supported access and backhaul links (such as, backhaul communication link(s) 120). IAB node(s) 104 may include an IAB mobile termination (IAB-MT) controlled (such as, scheduled) by one or more DUs (such as, DUs 165) of a coupled IAB donor. An IAB-MT may be equipped with an independent set of antennas for relay of communications with UEs 115 or may share the same antennas (such as, of an RU 170) of IAB node(s) 104 used for access via the DU 165 of the IAB node(s) 104 (such as, referred to as virtual IAB-MT (vIAB-MT)). In some examples, the IAB node(s) 104 may include one or more DUs (such as, DUs 165) that support communication links with additional entities (such as, IAB node(s) 104, UEs 115) within the relay chain or configuration of the access network (such as, downstream). In such cases, one or more components of the disaggregated RAN architecture (such as, the IAB node(s) 104 or components of the IAB node(s) 104) may be configured to operate according to the techniques described herein.

For instance, an access network (AN) or RAN may include communications between access nodes (such as, an IAB donor), IAB node(s) 104, and one or more UEs 115. The IAB donor may facilitate connection between the core network 130 and the AN (such as, via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (such as, a backhaul link). The IAB donor and IAB node(s) 104 may communicate via an F1 interface according to a protocol that defines signaling messages (such as, an F1 AP protocol). Additionally, or alternatively, the CU 160 may communicate with the core network 130 via an interface, which may be an example of a portion of a backhaul link, and may communicate with other CUs (such as, including a CU 160 associated with an alternative IAB donor) via an Xn-C interface, which may be an example of another portion of a backhaul link.

IAB node(s) 104 may refer to RAN nodes that provide IAB functionality (such as, access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (such as, an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (such as, the IAB node(s) 104) to receive signaling from a parent IAB node (such as, the IAB node(s) 104), and a DU interface (such as, a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (such as, backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (such as, transmissions to the UEs 115 relayed from the IAB donor) through one or more DUs (such as, DUs 165). That is, data may be relayed to and from IAB node(s) 104 via signaling via an NR Uu interface to MT of IAB node(s) 104 (such as, other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support uplink message repetitions for SBFD-aware devices as described herein. For example, some operations described as being performed by a UE 115 or a network entity 105 (such as, a base station 140) may additionally, or alternatively, be performed by one or more components of the disaggregated RAN architecture (such as, components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (such as, one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (such as, a bandwidth part (BWP)) that is operated according to one or more PHY layer channels for a given RAT (such as, LTE, LTE-A, LTE-A Pro, NR). Each PHY layer channel may carry acquisition signaling (such as, synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as, entity, sub-entity) of a network entity 105. For example, the terms “transmitting,” “receiving,” or “communicating,” when referring to a network entity 105, may refer to any portion of a network entity 105 (such as, a base station 140, a CU 160, a DU 165, a RU 170) of a RAN communicating with another device (such as, directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (such as, an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (such as, of the same or a different RAT).

The communication link(s) 125 of the wireless communications system 100 may include downlink transmissions (such as, forward link transmissions) from a network entity 105 to a UE 115, uplink transmissions (such as, return link transmissions) from a UE 115 to a network entity 105, or both, among other configurations of transmissions. Carriers may carry downlink or uplink communications (such as, in an FDD mode) or may be configured to carry downlink and uplink communications (such as, in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (such as, 1.4, 3, 5, 10, 15, 20, 40, or 80 megahertz (MHz)). Devices of the wireless communications system 100 (such as, the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (such as, a sub-band, a BWP) or all of a carrier bandwidth.

Signal waveforms transmitted via a carrier may be made up of multiple subcarriers (such as, using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as, a duration of one modulation symbol) and one subcarrier, in which case the symbol period and subcarrier spacing may be inversely related. The quantity of bits carried by each resource element may depend on the modulation scheme (such as, the order of the modulation scheme, the coding rate of the modulation scheme, or both), such that a relatively higher quantity of resource elements (such as, in a transmission duration) and a relatively higher order of a modulation scheme may correspond to a relatively higher rate of communication. A wireless communications resource may refer to a combination of an RF spectrum resource, a time resource, and a spatial resource (such as, a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (such as, 10 milliseconds (ms)). Each radio frame may be identified by a system frame number (SFN) (such as, ranging from 0 to 1023).

Each frame may include multiple consecutively-numbered subframes or slots, and each subframe or slot may have the same duration. In some examples, a frame may be divided (such as, in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as, depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (such as, N_{f}) sampling periods. The duration of a symbol period may depend on the subcarrier spacing or frequency band of operation.

A subframe, a slot, a mini-slot, or a symbol may be the smallest scheduling unit (such as, in the time domain) of the wireless communications system 100 and may be referred to as a transmission time interval (TTI). In some examples, the TTI duration (such as, a quantity of symbol periods in a TTI) may be variable. Additionally, or alternatively, the smallest scheduling unit of the wireless communications system 100 may be dynamically selected (such as, in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (such as, a control resource set (CORESET)) for a physical control channel may be defined by a set of symbol periods and may extend across the system bandwidth or a subset of the system bandwidth of the carrier. One or more control regions (such as, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as, control channel elements (CCEs)) associated with encoded information for a control information format having a given payload size. Search space sets may include common search space sets configured for sending control information to UEs 115 (such as, one or more UEs) or may include UE-specific search space sets for sending control information to a UE 115 (such as, a specific UE).

A network entity 105 may provide communication coverage via one or more cells such as a macro cell, a small cell, a hot spot, or other types of cells, or any combination thereof. The term “cell” may refer to a logical communication entity used for communication with a network entity 105 (such as, using a carrier) and may be associated with an identifier for distinguishing neighboring cells (such as, a physical cell identifier (PCID), a virtual cell identifier (VCID)). In some examples, a cell also may refer to a coverage area 110 or a portion of a coverage area 110 (such as, a sector) over which the logical communication entity operates. Such cells may range from smaller areas (such as, a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (such as, several kilometers in radius) and may allow unrestricted access by the UEs 115 with service subscriptions with the network provider supporting the macro cell. A small cell may be associated with a network entity 105 operating with lower power (such as, a base station 140 operating with lower power) relative to a macro cell, and a small cell may operate using the same or different (such as, licensed, unlicensed) frequency bands as macro cells. Small cells may provide unrestricted access to the UEs 115 with service subscriptions with the network provider or may provide restricted access to the UEs 115 having an association with the small cell (such as, the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (such as, MTC, narrowband IoT (NB-IoT), enhanced mobile broadband (eMBB)) that may provide access for different types of devices.

In some examples, a network entity 105 (such as, a base station 140, an RU 170) may be movable and therefore provide communication coverage for a moving coverage area, such as the coverage area 110. In some examples, coverage areas 110 (such as, different coverage areas) associated with different technologies may overlap, but the coverage areas 110 (such as, different coverage areas) may be supported by the same network entity (such as, a network entity 105). In some other examples, overlapping coverage areas, such as a coverage area 110, associated with different technologies may be supported by different network entities (such as, the network entities 105). The wireless communications system 100 may include, for example, a heterogeneous network in which different types of the network entities 105 support communications for coverage areas 110 (such as, different coverage areas) using the same or different RATs.

The wireless communications system 100 may support synchronous or asynchronous operation. For synchronous operation, network entities 105 (such as, base stations 140) may have similar frame timings, and transmissions from different network entities (such as, different ones of the network entities 105) may be approximately aligned in time. For asynchronous operation, network entities 105 may have different frame timings, and transmissions from different network entities (such as, different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (such as, via Machine-to-Machine (M2M) communication). M2M communication or MTC may refer to data communication technologies that allow devices to communicate with one another or a network entity 105 (such as, a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (such as, a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (such as, according to narrowband communications), or a combination of these techniques. For example, some UEs 115 may be configured for operation using a narrowband protocol type that is associated with a defined portion or range (such as, set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (such as, one or more of the UEs 115) via a device-to-device (D2D) communication link, such as a D2D communication link 135 (such as, in accordance with a peer-to-peer (P2P), D2D, or sidelink protocol). In some examples, one or more UEs 115 of a group that are performing D2D communications may be within the coverage area 110 of a network entity 105 (such as, a base station 140, an RU 170), which may support aspects of such D2D communications being configured by (such as, scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (such as, UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (such as, network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as, a mobility management entity (MME), an access and mobility management function (AMF)) and at least one user plane entity that routes packets or interconnects to external networks (such as, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as, base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (such as, less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (such as, from 30 GHz to 300 GHz), also known as the millimeter band. In some examples, the wireless communications system 100 may support millimeter wave (mmW) communications between the UEs 115 and the network entities 105 (such as, base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (such as, LAA). Operations using unlicensed spectrum may include downlink transmissions, uplink transmissions, P2P transmissions, or D2D transmissions, among other examples.

A network entity 105 (such as, a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (such as, the same codeword) or different data streams (such as, different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (such as, a network entity 105, a UE 115) to shape or steer an antenna beam (such as, a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as, with respect to the antenna array of the transmitting device or receiving device, or with respect to some other orientation).

A network entity 105 or a UE 115 may use beam sweeping techniques as part of beamforming operations. For example, a network entity 105 (such as, a base station 140, an RU 170) may use multiple antennas or antenna arrays (such as, antenna panels) to conduct beamforming operations for directional communications with a UE 115. Some signals (such as, synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (such as, by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (such as, a network entity 105 or a UE 115) along a single beam direction (such as, a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (such as, by a network entity 105 or a UE 115) may be performed using multiple beam directions, and the device may use a combination of digital precoding or beamforming to generate a combined beam for transmission (such as, from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (such as, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (such as, a multi-panel type codebook, a linear combination type codebook, a port selection type codebook). Although these techniques are described with reference to signals transmitted along one or more directions by a network entity 105 (such as, a base station 140, an RU 170), a UE 115 may employ similar techniques for transmitting signals multiple times along different directions (such as, for identifying a beam direction for subsequent transmission or reception by the UE 115) or for transmitting a signal along a single direction (such as, for transmitting data to a receiving device).

A receiving device (such as, a UE 115) may perform reception operations in accordance with multiple receive configurations (such as, directional listening) when receiving various signals from a transmitting device (such as, a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (such as, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (such as, when receiving a data signal). The single receive configuration may be aligned along a beam direction determined based on listening according to different receive configuration directions (such as, a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (such as, the communication link(s) 125, a D2D communication link 135). HARQ may include a combination of error detection (such as, using a cyclic redundancy check (CRC)), forward error correction (FEC), and retransmission (such as, automatic repeat request (ARQ)). HARQ may improve throughput at the MAC layer in relatively poor radio conditions (such as, low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein

A UE 115 may receive control signaling indicating a first set of uplink occasions corresponding to a first type of uplink occasions, and a second set of uplink occasions corresponding to a second type of uplink occasions, where the first type of uplink occasions are SBFD uplink occasions, and the second type of uplink occasions are non-SBFD occasions. The UE 115 may further receive second control signaling indicating a first configuration supporting wireless communications via the first type of symbols or the second type of symbols, or a second configuration supporting wireless communications via both the first type of symbols and the second type of symbols. The UE 115 may perform resource selection (such as, a slot counting procedure) and may select uplink occasions for uplink repetitions, and may transmit one or more repetitions of an uplink message via the selected (such as, counted) one or more uplink occasions.

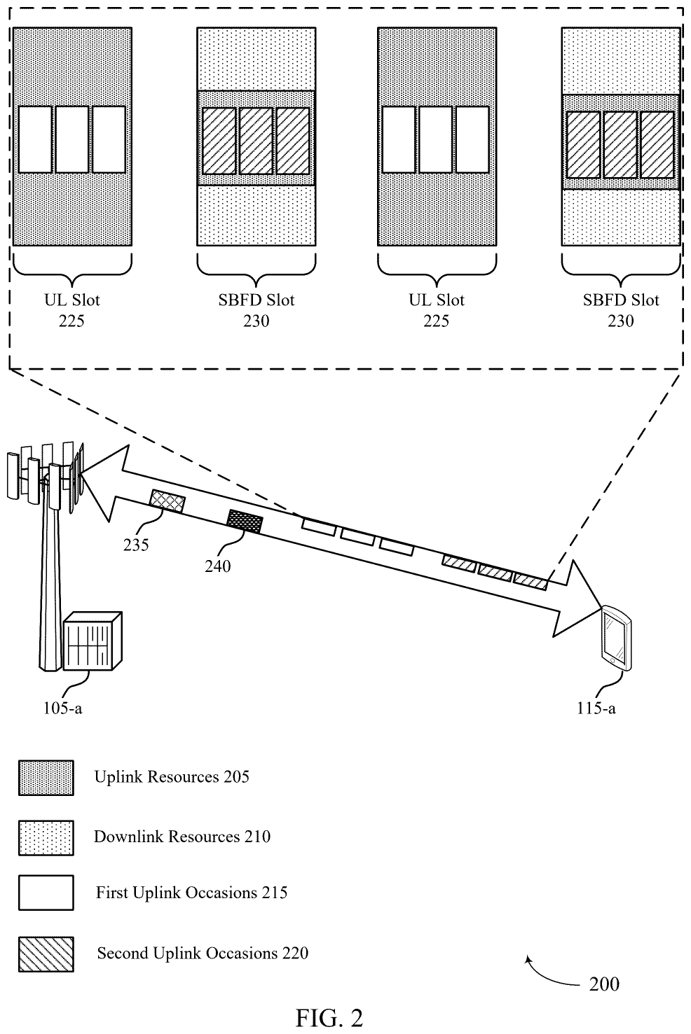

FIG. 2 shows an example of a wireless communications system 200 that supports uplink message repetitions for SBFD-aware devices. The wireless communications system 200 may implement, or be implemented by, aspects of the wireless communications system 100. For example, a UE (such as, a UE 115) and a network entity (such as, a network entity 105), which may be examples of corresponding devices described with reference to FIG. 1, may communicate in accordance with the wireless communications system 200.

The wireless communications system may support wireless communications via uplink occasions (such as, via physical uplink shared channel (PUSCH) resources, such as uplink occasions). The UE 115-a may receive control signaling scheduling uplink transmissions via uplink resources 205 (such as, PUSCH resources). For instance, the UE 115-a may monitor for one or more synchronization signal physical broadcast channel blocks (SSBs) and may select a corresponding RO via which to transmit a first random access message.

Some uplink occasions (such as, first uplink occasions 215) may be located in uplink or flexible slots (such as, uplink slots 225). Some ROs (such as, second uplink occasions 220) may be located in uplink resources 205 (such as, an uplink subband) in an SBFD slot 230 (such as, which includes both uplink resources 205 and downlink resources 210). In some examples, first uplink occasions 215 may be referred to as non-SBFD uplink occasions (such as, legacy ROs in a random access procedure), and second uplink occasions 220 may be referred to as SBFD uplink occasions. Some wireless devices may not support SBFD modes of operation, and may only be capable of transmitting random access signaling via the first uplink occasions 215. Other UEs (such as, SBFD-aware UEs) may be capable of transmitting random access signaling via the first uplink occasions 215, and via the second uplink occasions 220.

In some examples, first control signaling 235 may indicate first uplink occasions 215, second uplink occasions 220, or both. For instance, in a random access scenario (such as, in which case the uplink occasions may include random access occasions (ROs), the wireless communications system 200 may support one or more configurations of the ROs. In some examples, the UE 115-a may receive the first control signaling 235 including a single shared physical random access channel (PRACH) configuration indicating both the first uplink occasions 215, and additional second uplink occasions 220. A UE that is not capable of supporting the SBFD operations may consider the second uplink occasions 220 (such as, SBFD ROs) invalid. The UE 115-a may be an SBFD-aware UE, and may consider the second uplink occasions 220 as valid ROs. For example, a single RACH configuration using a single PRACH configuration index may indicate both the first ROs and the second ROs. Or, in some examples, two different RACH configuration with separate PRACH configuration indices may be utilized to configure the first ROs, and the second ROs. In some examples, the UE 115-a may receive a first configuration of the first uplink occasions 215, and a second configuration (such as, an SBFD-dedicated PRACH configuration) of the second uplink occasions 220. In either scenario, the UE 115-a may be capable of selecting an uplink occasions of the first uplink occasions 215, or an uplink occasions of the second uplink occasions 220 for transmitting an uplink message via a PUSCH (such as, a random access message via a selected RO).

Uplink signaling may be scheduled by control signaling. For instance, a random access message (such as, a third message, such as message 3 of a four-step random access procedure) may be scheduled by a random access response (such as, message two) uplink grant, or a fallback random access response grant (such as, a two-step random access procedure falling back to a four-step random access procedure). In some examples, a downlink control information (DCI) message (such as, a DCI format 0_0 with a cyclic redundancy check (CRC) scrambled by a temporary cellular radio network temporary identifier (TC-RNTI)) may schedule a retransmission of an uplink message.

Such uplink messages may be single-slot transmissions, or may be multi-slot transmissions (such as, configured with repetition Type A). For single slot transmissions, the slot via which the uplink message is transmitted (such as, an uplink slot 225 or a SBFD slot 230) may be indicated by one or more parameters, such as a slot offset value (such as, which may be referred to as a reference slot or a K2 offset). For multi-slot transmissions (such as, repetitions of an uplink message, such as a PUSCH Type A repetition with available slot counting), the resources via which the UE 115-a is to transmit the message may be determined according to one or more parameters. Such parameters may include a K2 offset which represents a reference slot for determining a quantity of available slots (such as, K available slots), a quantity of K available slots, a quantity of repetitions (such as, which may be indicated by one or more bits, such as two most significant bits, of a modulation and coding scheme (MCS) bitfield), or other parameters. Such parameters may be indicated via control signaling (such as, the second control signaling 240), such as system information (such as, system information block (SIB) 1. In some examples, the system information may indicate a quantity (such as, four) of candidate values for repetitions, and dynamic signaling (such as, a DCI or media access control (MAC) control element (CE) may indicate which of the candidate repetition values is to be applied for a scheduled uplink message. For instance, different code points of an indication (such as, a numberofMsg3-ReptitionList) or one or more bits of an MCS information field may indicate different values for the quantity K of available slots via which the UE 115-a is to transmit the uplink message.

In some example, the UE 115-a may perform a slot counting procedure (such as, an available slot counting procedure). In such examples, the UE 115-a may count up to the K available slots based on whether a slot is available (such as, valid) for an uplink transmission (such as, in accordance with one or more rules or conditions, which may be indicated to the UE 115-a via control signaling, or may be defined in one or more standards documents). For example, the UE 115-a may receive control signaling (such as, the first control signaling 235) indicating which slots are allocated as flexible slots or uplink slots 225, and which slots are allocated as downlink slots (such as, unavailable or invalid slots), and which slots are allocated as SBFD slots 230 (such as, the parameter tdd-UL-DL-ConfigurationCommon). The UE 115-a may also receive signaling indicating one or more SSBs (such as, the parameter ssb-PositionInBurst). In some examples, the UE 115-a may consider a slot to be valid (such as, available) for an uplink repetition if consecutive symbols allocated for repetition (such as, a first uplink occasion 215 or a second uplink occasion 220) are all available symbols (such as, uplink symbols or flexible symbols).

In some examples, the network entity 105-a may configure the UE 115-a to perform uplink transmission repetitions with frequency hopping, in which case the UE 115-a may receive control signaling (such as, a DCI message) indicating frequency locations and frequency hopping offset values. For instance, the frequency domain resource allocation (FDRA) in a DCI message may be based on a resource indicator value (RIV) (such as, a resource allocation Type 1). A PUSCH repetition (such as, a PUSCH repetition Type A scheduled by a random access response uplink grant, or by a DCI format 0-0 with CRC scrambled by TC-RNTI, etc.) may be configured for frequency hopping by a frequency hopping flag information field of an uplink grant. In some examples, a quantity of bits (such as, 1 or 2-bits N_{UL-hop}) may be determined as 1-2 most significant bits of the FDRA. IN some examples, inter-slot frequency hopping may be supported for uplink repetition (such as, message 3 repetitions). In some examples, the frequency hopping flag information field may be used to enable or disable inter-slot frequency hopping. A grant indicating frequency hopping for uplink repetition may include a frequency hopping field, a PUSCH frequency resource allocation, a PUSCH time resource allocation, an MCS indication, a TPC command for PUSCH transmissions, a CSI request, a channel Access cyclic prefix extension, or the like. PUSCH transmissions with frequency hopping scheduled by an uplink grant for a transmission or retransmission with repetition may be scheduled with a frequency offset value for a second hop. The second hop may be based on a bandwidth part (BWP) size (such as, the BWP divided by 2, or 4, among other examples).

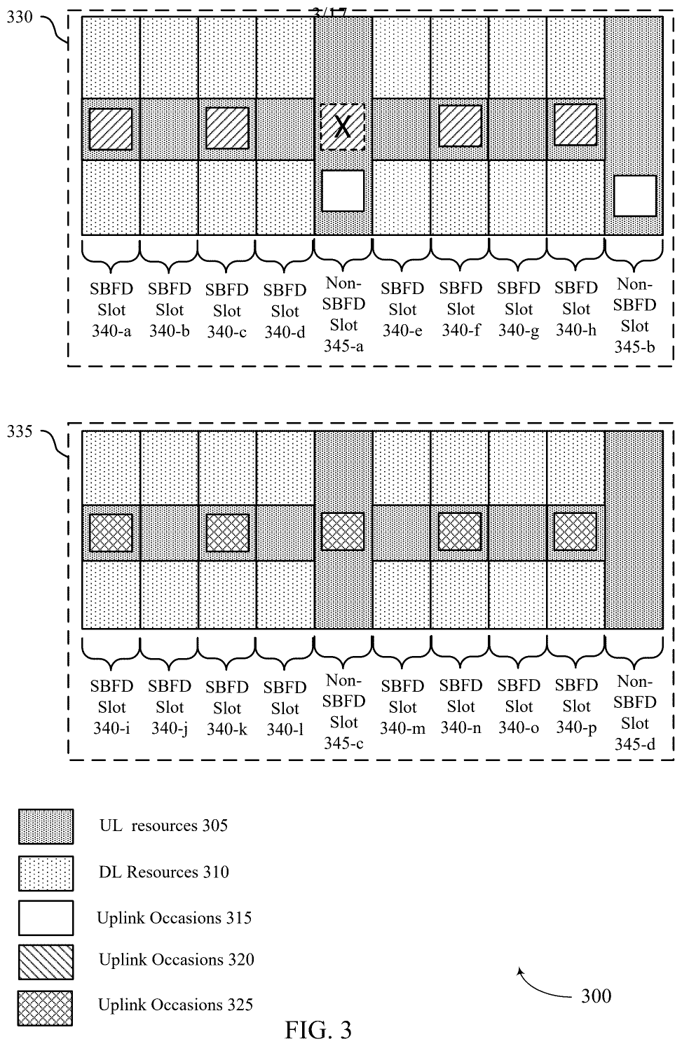

In some examples, the wireless communications system may support one or more configurations of the uplink occasions. For example, to support uplink transmission and downlink transmissions across SBFD symbols and non-SBFD symbols in different slots (such as, each transmission within a slot may occur via either all SBFD symbols or all non-SBFD symbols) an SBFD aware UE (such as, the UE 115-a) may be provided with a configuration indicating which resources are available (such as, valid) for one or more transmission. The UE 115-a may receive the second control signaling 240, which may indicate a first configuration (such as, configuration 1), or a second configuration (such as, configuration 2). As described in greater detail with reference to FIG. 3, according to the first configuration, transmissions and receptions are restricted to SBFD symbols, or are restricted to non-SBFD symbols. According to the second configuration, transmissions and receptions may occur in SBFD symbols and non-SBFD symbols. In some cases, a granularity of the configuration may be per UE, per channel, per signal, or the like. In some examples, the UE 115-a may indicate support of configuration 1, configuration 2, or both, as described herein.

In some examples, the UE 115-a may be configured with one or more uplink occasions across various slots, which may include uplink slots 225 (such as, or flexible slots) and SBFD slots 230 (such as, first uplink occasions 215 or second uplink occasions 220 or both). In such examples, without a mechanism or rule for determination, it may be unclear to the UE which uplink occasions are available or valid for uplink transmissions. For example, in the case of repetitions for an uplink message, the UE 115-a may perform an uplink counting procedure. The UE 115-a may count available slots, but if the UE 115-a and the network entity 105-a are not adhering to the same selection rules (such as, determining the same slots to be valid or invalid), then uplink transmission may fail, throughput may decrease, available system resources may be inefficiently allocated or utilized, system latency may increase, and user experience may be negatively impacted.

Techniques described herein provide for wireless signaling and rules for uplink occasion selection (such as, slot counting) to ensure that the UE 115-a and the network entity 105-a are able to efficiently determine which resources to use for uplink repetitions. The network entity 105-a may indicate (such as, via the second control signaling 240) support of uplink repetition via one or more resources (such as, first uplink occasions 215, second uplink occasions 220, or both), and the UE 115-a may interpret such indications according to one or more rules or techniques described herein (such as, the indication of supported uplink repetitions may indicate that the uplink repetition is supported in non-SBFD symbols, or in SBFD symbols, or the indication of supported uplink repetitions may indicate that the uplink repetition is supported in both non-SBFD symbols and SBFD symbols). The UE 115-a may indicate that it is capable of uplink repetitions (such as, via a feature combination indicated by a selected random access resources such as a preamble or an RO), and such an indication may indicate which resources will be considered valid (such as, the UE 115-a may indicate support of uplink repetitions via SBFD symbols or non-SBFD symbols according to the first configuration, or may indicate support of uplink repetitions via both SBFD symbols and non-SBFD symbols). The UE 115-a may then determine valid slots for uplink repetitions (such as, may perform available slot counting and select uplink occasions) in accordance with the resource configuration indicated via the first control signaling 235, and in accordance with the features supported by the network entity 105-a as indicated via the second control signaling 240.

FIG. 3 shows an example of a resource configuration scheme 300 that supports uplink message repetitions for SBFD-aware devices. The resource configuration scheme 300 may implement, or be implemented by, aspects of the wireless communication system 100, and the wireless communications system 200. For example, a UE (such as, a UE 115) and a network entity (such as, a network entity 105), which may be examples of corresponding devices described with reference to FIGS. 1-2, may communicate with each other in accordance with the resource configuration scheme 300. As described with reference to FIG. 2, the network entity may transmit control signaling (such as, the second control signaling 240) indicating a first configuration 330, or a second configuration 335. In some examples, control signaling (such as, the first control signaling 235) may allocate resources as uplink slots, downlink slots, flexible slots, SBFD slots 340, non-SBFD slots 345, etc. SBFD slots 340 may include uplink subbands and downlink subbands (e.g., uplink resources 305 and downlink resources 310). Non-SBFD slots 345 may include uplink resource 305 (e.g., in the case of flexible or uplink slots). The first configuration 330 may correspond to the SBFD slot 340-a, SBFD slot 340-b, SBFD slot 340-c, SBFD slot 340-d, non-SBFD slot 345-a, SBFD slot 340-c, SBFD slot 340-f, SBFD slot 340-g, SBFD slot 340-h, and non-SBFD slot 345-b. The second configuration 335 may correspond to SBFD slot 340-i, SBFD slot 340-j, SBFD slot 340-k, SBFD slot 340-1, non-SBFD slot 345-c, SBFD slot 340-m, SBFD slot 340-n, SBFD slot 340-o, SBFD slot 340-p, and non-SBFD slot 345-d.

The first configuration 330 may indicate that wireless communications are restricted to SBFD symbols (such as, in SBFD slots 340) or non-SBFD symbols (such as, in non-SBFD slots 345). In such examples, uplink occasions may occur (such as, may be scheduled) in SBFD slots 340, non-SBFD slots 345, or both. For instance, periodic SBFD uplink occasions (such as, uplink occasions 320) may be located in the SBFD slot 340-a, the SBFD slot 340-c, the non-SBFD slot 345-a, the SBFD slot 340-f, and the SBFD slot 340-h. Uplink occasions 315 (such as, periodic non-SBFD uplink occasions) may be located in the non-SBFD slot 345-a, and the non-SBFD slot 345-b. In the case of the first configuration 330, if uplink transmissions (such as, uplink repetitions) are limited to SBFD symbols, then the UE may select (such as, count as available or valid) the uplink occasions 320 in the SBFD slot 340-a, the SBFD slot 340-c, the SBFD slot 340-f, and the SBFD slot 340-h. In some examples, the uplink occasion 320 located in the non-SBFD slot 345-a may not be considered valid under the first configuration 330 (such as, because it is not located in SBFD symbols). In the case of the first configuration 330, if uplink transmissions (such as, such as uplink repetitions) are limited to non-SBFD symbols, then the UE may select (such as, count as available or valid) the uplink occasion 315 in the non-SBFD slot 345-a, and the uplink occasion 315 in the non-SBFD slot 345-b. In some examples, the uplink occasion 320 located in the non-SBFD slot 345-a (such as, because the uplink occasion 320 is associated with an SBFD configuration).

The second configuration 335 may indicate that wireless communications are supported in SBFD symbols (such as, in SBFD slots 340) or non-SBFD symbols (such as, in non-SBFD slots 345). In such examples, uplink occasions may occur (such as, may be scheduled) in SBFD slots 340, non-SBFD slots 345, or both. For instance, periodic SBFD uplink occasions (such as, uplink occasions 325) may be located in the SBFD slot 340-i, the SBFD slot 340-k, the non-SBFD slot 345-c, the non-SBFD slot 345-a, the SBFD slot 340-n, and the SBFD slot 340-p. Uplink occasions 325 may be supported in both SBFD slots 340 and non-SBFD slots 345. In the case of the second configuration 335, the UE may select (such as, count as available or valid) the uplink occasions 325 in the SBFD slots 340, the non-SBFD slots 345, or both, according to one or more techniques or rules described herein.

As described herein, the UE may receive control signaling (such as, the second control signaling 240) indicating that the network entity supports uplink repetition (such as, message 3 repetition, in a random access scenario, a data transmission, a retransmission, or the like) according to the first configuration 330 or the second configuration 335. The UE may select uplink occasions in one or more slots for repetitions of an uplink message according to the indication of the first configuration 330 or the second configuration 335, and one or more rules as described herein. In some examples, such rules (such as, rules indicating which uplink resources are to be considered valid, which slots are to be counted, which configuration is to be applied, etc.) may be indicated to the UE via control signaling, or may be defined in one or more standards documents.

Techniques described herein may result in improved reliability of wireless signaling, increased throughput, more efficient use of available system resources, decreased system latency, and improved user experience. Specifically, according to techniques described herein, a UE may receive control signaling and apply one or more rules to interpret the received control signaling, based on which the UE may efficiently select valid uplink occasions for repetitions of uplink transmissions. The clarity provided by the signaling, the rules, or both, may increase the reliability of the uplink repetitions and the efficient use of available system resources allocated for uplink repetitions. The increased reliability of uplink repetitions may result in more efficient and reliable random access signaling or uplink data signaling, and may result in avoided collisions or failed uplink transmissions

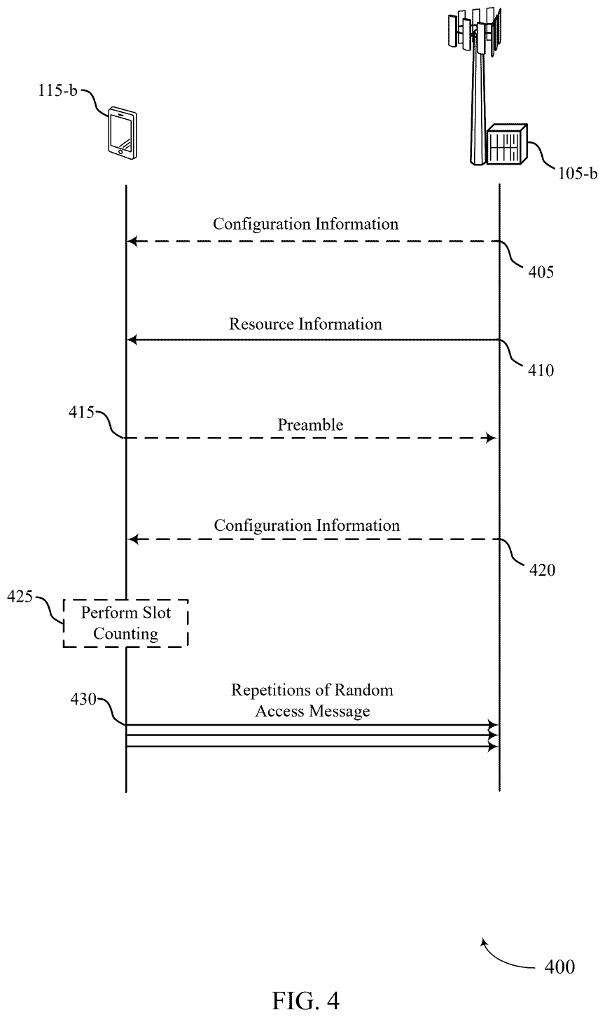

FIG. 4 shows an example of a process flow 400 that supports uplink message repetitions for SBFD-aware devices. The process flow 400 may implement, or be implemented, by aspects of the wireless communications system 100, the wireless communications system 200, or the resource configuration scheme 300. For example, the process flow 400 may include a UE 115-b and a network entity 105-b, which may be examples of corresponding devices described with reference to FIGS. 1-3.

The UE 115-b may receive (such as, at 410) control signaling indicating resource information. For example, the control signaling may indicate a first set of uplink occasions corresponding to a first type of uplink occasions, and a second set of uplink occasions corresponding to a second type of uplink occasions. The first type of uplink occasions correspond to a first type of symbols supporting a SBFD mode of operation (such as, SBFD symbols), and the second type of uplink occasions corresponds to a second type of symbols supporting a half duplex mode of operation (such as, non-SBFD symbols).

The UE 115-b may receive (such as, at 405 or at 420) control signaling including configuration information. For example, the second control signaling may indicate a first configuration supporting wireless communications via the first type of symbols or the second type of symbols (such as, the first configuration 330), or a second configuration supporting wireless communications via both the first type of symbols and the second type of symbols (such as, the second configuration 335).

At 425, the UE 115-b may perform a slot counting procedure (such as, an available slot counting procedure). The UE 115-b may select (such as, count) one or more uplink occasions in accordance with the slot counting procedure based on the first configuration, or the second configuration, according to techniques described herein. The configuration information may be applied according to one or more rules. For example, the UE 115-b may apply the configuration information according to one or more rules, as described herein.

In some examples, the network entity 105-b may indicate (such as, via configuration information) feature combinations supported by the network entity 105-b. The network entity 105-b may indicate the feature combinations via control signaling (such as, at 405), and may further indicate a correspondence between random access resources (such as, random access preambles, or ROs) corresponding to different supported features. The UE 115-b may then transmit a random access preamble via resources selected to indicate supported capabilities at the UE 115-b (such as, at 415). Indicating support for a feature by the UE 115-b (such as, based on selection of random access resources for a random access preamble) may be referred to as an early indication.

The network entity 105-b may indicate a support of feature combinations (such as, via system information) at 405. For example, the configuration information may include an indication of a feature combination supported by the network entity 105-b (such as, uplink repetition, or msg3-reptition, among other examples). Such an indication may represent support of uplink repetition (such as, such as message 3) in one type of symbol (such as, non-SBFD symbols). For instance, the UE 115-b may not support SBFD random-access procedures (such as, which the UE 115-b may indicate via an early indication of SBFD-awareness).

In some examples, the indication of feature combination including uplink message repetition may indicate support of uplink repetitions in non-SBFD symbols, (such as, but not in SBFD symbols according to the first configuration). In some examples, the indication of feature combination including uplink message repetition may indicate support of uplink repetitions in SBFD symbols (such as, but not in non-SBFD symbols according to the first configuration). For example, the UE 115-b may support an early indication of SBFD-awareness. The network entity 105-b may schedule uplink repetitions in one of SBFD symbols or non-SBFD symbols based thereon.

In some examples, the indication of feature combination including uplink message repetition may indicate support of uplink repetitions across SBFD and non-SBFD symbols (such as, in accordance with the second configuration). For example, the UE 115-b may support an early indication of SBFD-awareness. The network entity 105-b may schedule uplink repetitions across both SBFD symbols and non-SBFD symbols based on the early indication.

In some examples (such as, according to one or more rules), an indication (such as, by the UE 115-b) of one or more supported feature combinations (such as, SBFD+msg3-repetitions) may represent support of uplink repetitions in SBFD symbols only (such as, according to the first configuration) or support of uplink repetitions in non-SBFD symbols only (such as, according to the first configuration. In some examples, the indication of one or more supported feature combinations by the UE 115-b may represent support of uplink repetitions in both SBFD and non-SBFD symbols (such as, according to the second configuration).

In some examples, a default mode for message repetition may be based on the first configuration (such as, message repetitions, such as message 3 of a random access procedure, may be supported in non-SBFD symbols or SBFD symbols, but not both). For example, selecting a first uplink occasion of the one or more uplink occasions for uplink repetitions at 430 may be based on a validity of one or more symbols of the first uplink occasion in accordance with the slot counting procedure. The validity of the one or more symbols may be based on an indication in a random access message (such as, a DCI or MAC-CE received at 420), a reference slot type indicated via the second control signaling (such as, received at 405 or at 420), a symbol type corresponding to the symbol via which the random access message is received (such as, at 420), or any combination thereof.

In some such examples, at 425, the UE 115-b may perform slot counting to determine which slots (such as, which uplink occasions within a given slot) are valid. A valid symbol type may be determined based on an explicit indication in a DCI field. For example, at 420, the UE 115-b may receive a DCI message (such as, a random access response uplink grant, or a grant for retransmissions, or the like). The DCI may include a field explicitly indicating that the UE 115-b is to consider SBFD slots, or non-SBFD slots as valid, or invalid (such as, according to the first configuration). In some examples, valid symbol types may be indicated by a reference slot type given by a slot offset value (such as, K2). For example, the DCI message received at 415 (such as, or additional configuration such as a quantity of slots K, and the K2 value, etc., received at 405) may be a non-SBFD slot (such as, an uplink, downlink or flexible slot), in which case the K2 value indicates that non-SBFD slots are valid (such as, and SBFD slots are invalid). Similarly, if the K2 value indicates an SBFD slot, then non-SBFD slots may be considered invalid. In some examples, the slot or symbols via which the UE 115-b receives the configuration information (such as, the slot or symbol via which the UE 115-b receives a DCI, MAC-CE, random access response grant, a fallback random access response grant, a message 2, or the like) may define which type of symbol is valid. For instance, if the configuration information at 420 is received via SBFD symbols, then the UE 115-b may determine that SBFD slot are considered valid (such as, and non-SBFD symbols are considered invalid). Similarly, if the configuration information at 420 is received via non-SBFD symbols, ten the UE 115-b may determine that the non-SBFD symbols are valid (such as, and that the SBFD slots are considered invalid). Such techniques may also be applied in reverse (such as, in which case the symbol or slot via which the DCI is received or indicated by K2 may be the invalid symbol type).

In some examples, a slot in which an uplink occasion is located may be a mixed slot (such as, including both SBFD resources and non-SBFD resources. In such examples, selecting the first uplink occasion of the one or more uplink occasions for uplink repetition at 430 may be based on a validity of one or more symbols of the first uplink occasion in accordance with the slot counting procedure. The first uplink occasion may occur in a slot that is a first subset of the first type of symbols and a second subset of the second type of symbols. The validity of the one or more symbols may be based at least in part on a time domain resource allocation in the random access message, a symbol type of a first in time symbol of the slot, a default type of symbol comprising the second type of symbol, or any combination thereof.

In some such examples, for a mixed slot (such as, including SBFD symbols and non-SBFD symbols), a valid symbol type may be given by an explicit allocation of symbol types according to a time domain resource allocation (TDRA). For instance, a DCI message received at 420 may include a TDRA field, which may allocate the mixed slot as valid or invalid. In some examples, a valid symbol type (such as, for the uplink occasion in the mixed slot) may be given by the first symbol of the slot or the first symbol of the allocated PUSCH (such as, if the first symbol in the slot is an SBFD symbol, then SBFD symbols may be considered valid and non-SBFD symbols may be considered invalid). In some examples, a valid symbol type (such as, for the uplink occasion in the mixed slot) may be given by a default rule (such as, mixed slots may be always treated as non-SBFD repetitions, or may always be designated for SBFD-only repetitions).

In some examples, the network entity 105-b may configure the UE 115-b with a quantity of uplink repetitions for transmission at 430 (such as, via a reception list, such as numberofMsg3RepetitionList). Such a quantity (such as, or list) may be used to determine a quantity of repetitions for SBFD or non-SBFD repetitions. In such examples, selecting (such as, counting) the one or more uplink occasions according to the slot counting procedure may include counting slots that include the first type of symbols and do not include the second type of symbols in accordance with the control message and the first configuration. For example, the repetitions in SBFD symbols may be based on available slot counting, where valid symbols, counted towards the K repetitions, may be SBFD symbols (such as, but not non-SBFD symbols). In some examples, selecting (such as, counting) the one or more uplink occasions may be based on a physical slot counting procedure, and the first uplink occasion of the one or more uplink occasions may be located in the reference slot indicated by the slot offset value (such as, K2). In such examples, the repetition in SBFD symbols may be based on physical slot counting, where first repetition is given by K2.

In some illustrative examples, under the first configuration (such as, indicating only non-SBFD symbols for uplink repetition), a downlink slot may be indicated as the reference slot (such as, by K2), and may not be counted (such as, may be considered invalid). However, under the first configuration (such as, indicating only non-SBFD symbols for uplink repetition), an uplink slot indicated as the reference slot (such as, by K2) may be counted (such as, may be considered valid. A flexible slot under the first configuration indicating non-SBFD symbols for uplink repetition may be counted (such as, may be considered valid. An SBFD slot under the first configuration (such as, indicating only SBFD symbols) may be counted (such as, considered valid). However, if symbols of an uplink occasion in an otherwise valid slot (such as, such as an SBFD slot under configuration 1 indicating only SBFD symbols) overlap in time with synchronization signal symbols (such as, with a synchronization signal block (SSB)), then that slot may be considered invalid.

In some examples, at 425, the UE 115-b may refrain from selecting (such as, counting) one or more additional uplink occasions according to the slot counting procedure if the one or more additional uplink occasions include the first type of uplink occasion, or if a slot including an uplink occasion includes one or more symbols overlapping in time with an SSB. For example, under the first configuration (such as, indicating non-SBFD symbols), a valid symbol may be determined as non-SBFD symbols, but the slot may not be counted if the slot is an SBFD slot, or if non-SBFD symbols (such as, uplink or flexible symbols) and PUSCH allocations are overlapping with downlink or SSB symbols.

In some examples, at 425, the UE 115-b may refrain from selecting one or more additional uplink occasions according to the slot counting procedure if the one or more additional uplink occasions include the second type of uplink occasion, if a slot corresponding to an uplink occasion includes both the first type of symbol and the second type of symbol, or if the slot corresponding to the uplink occasion includes one or more symbols overlapping in time with an SSB. For example, under configuration 1, a valid symbol may be determined to be SBFD symbols. A slot may not be counted under such conditions (such as, according to one or more rules) if the slot includes non-SBFD symbols (such as, if an uplink slot or flexible or downlink slot is not configured with SBFD symbols), if the slot if a mixed slot (such as, including both SBFD and non-SBFD s symbols) and at least one symbol the PUSCH occurs in non-SBFD symbols, if the slot is an SBFD slot and at least one symbol of the PUSCH time resource overlaps with the SSB index, or any combination thereof. In some examples, a valid symbol may be determined to be an SBFD symbol, and a slot may be counted if all symbols of the PUSCH are within an uplink subband of the SBFD symbols and are not overlapping with any SSB symbols.

In some examples, the second configuration may be used for uplink repetitions (such as, such as message 3 repetitions). In such examples, the UE 115-b may perform slot counting at 425 and may select (such as, count) uplink occasions in accordance with the second configuration and a validity of multiple slots according to the slot counting procedure. The UE 115-b may refrain from selecting one or more additional uplink occasions according to the slot counting procedure if the one or more additional uplink occasions are located within downlink slots, or if an uplink occasion is located within a slot that includes both the first type of symbols and the second type of symbols, or if the slot corresponding to the uplink occasion comprises one or more symbols overlapping in time with a synchronization signal block. For example, under configuration 2, a slot may not be counted if it is a downlink slot and is not configured as an SBFD slot, if the slot includes SBFD symbols and at least one symbol of the PUSCH time resources overlap with an SSB index, if the slot is a mixed slot (such as, including both SBFD symbols and non-SBFD symbols) and a PUSCH allocation occurs across both symbol types, or any combination thereof.

The network entity 105-b may indicate support of the first configuration or the second configuration via control signaling. For example, the UE 115-b may receive system information (such as, SIBI at 405) including an indication of a feature combination (such as, featureCombination IE). The feature combination may indicate the first configuration or the second configuration (such as, in combination with SBFD-awareness, or uplink repetition, or individually). In some examples, the UE 115-b may receive (such as, at 420, or at 405) a MAC-CE (such as, a random access response grant, or a fallback random access response grant, among other examples) including a parameter indicating the first configuration or the second configuration. In some examples, the UE 115-b may receive (such as, at 420) a DCI message (such as, a DCI format 0_0). The DCI message may include a bitfield indicating the first configuration or the second configuration. In some examples, absence of such parameters or explicit indications may result in the UE 115-b using a default configuration (such as, the first configuration or the second configuration) according to a rule.

The uplink message may be configured with frequency hopping. For example, a DCI message triggering transmission of the uplink message may be received at 420. The DCI message may include an indication of a frequency hopping offset for repetitions of the uplink message to be transmitted. At 430, the UE 115-b may transmit the one or more repetitions of the uplink message is in accordance with the frequency hopping offset, and the frequency hopping offset may be based on a subband corresponding to the uplink message and the one or more uplink occasions.

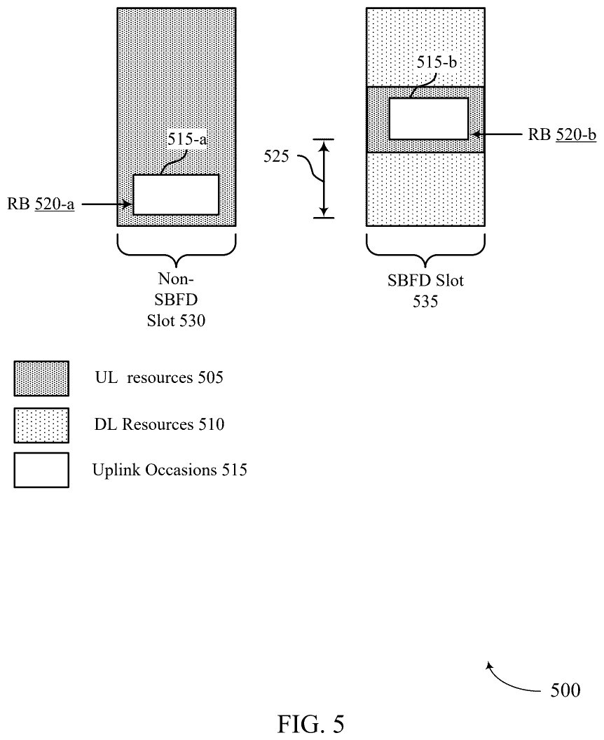

A bitfield in the DCI message may be utilized to indicate a quantity of frequency hopping offsets (such as, two or four frequency hopping offsets). The frequency hopping offsets may be determined according to Table 1 below, and a modular operation with respect to a size of a subband and starting resource block, determined with respect to a first useable uplink PRB in the uplink subband, as described in greater detail with reference to FIG. 5.

Having performed the slot counting procedure at 425 (such as, in accordance with the first configuration or the second configuration and one or more rules, as described herein), the UE 115-b may transmit one or more repetitions of an uplink message at 430.

FIG. 5 shows an example of a frequency hopping scheme 500 that supports uplink message repetitions for SBFD-aware devices. The frequency hopping scheme 500 may implement, or be implemented by, aspects of the wireless communications system 100, the wireless communications system 200, the resource configuration scheme 300, the process flow 400, or any combination thereof. For example, a UE (such as, a UE 115) and a network entity (such as, a network entity 105) may communicate in accordance with the frequency hopping scheme 500. The frequency hopping scheme 500 may support uplink repetitions via one or more uplink occasions (such as, the uplink occasion 515-a in the non-SBFD slot 530, and the uplink occasion 515-b in the SBFD slot 535). The non-SBFD slot 530 may be an uplink slot or a flexible slot, and may include uplink resources 505. The SBFD slot 535 may include downlink resources 510 (such as, in downlink SBs), and uplink resources 505 (such as, in an uplink SB).

The UE may transmit uplink repetitions of an uplink message according to one or more frequency hopping offsets. The frequency hopping offsets may be determined based on a subband size, or a size of useable uplink physical resource blocks (PRBs) (such as, instead of a bandwidth size). A quantity of the frequency hops may be determined based on a size of the uplink BWP size or the size of the subband. Equation 1 may be utilized to determine intra-slot and inter-slot frequency hopping such that a modular operation is performed with respect to a size of a starting subband and a starting resource block, and the starting resource block may be determined with respect to a first useable uplink PRB in the uplink subband. For example, the starting RB may be defined according to Equation 1:

$${B}_{start} = \{ \begin{matrix}{RB}_{start} , i = 0 \\ ( {RB}_{start} + {RB}_{offset} ) mod {N}_{RB}^{size} , i = 1\end{matrix} \qquad Equation 1$$

Table 1 further defines the frequency offsets in accordance with a number of PRBs in the uplink subband within the initial uplink BWP, and the value N_{UL-hops} indicated via control signaling.

TABLE 1

| Number | | Frequency offset of | Frequency offset of |
|---|---|---|---|
| of | Value of | second hop (non- | send hop (SBFD |
| PRBs | N_{UL-hops} | SBFD symbols) | symbols) |
| | 0 | $⌊ \frac{{N}_{BWP}^{size}}{2} ⌋$ | $⌊ \frac{{N}_{SB}^{size}}{2} ⌋$ |
| | 1 | $⌊ \frac{{N}_{BWP}^{size}}{4} ⌋$ | $⌊ \frac{{N}_{SB}^{size}}{4} ⌋$ |
| | 00 | $⌊ \frac{{N}_{BWP}^{size}}{2} ⌋$ | $⌊ \frac{{N}_{SB}^{size}}{2} ⌋$ |
| | 01 | $⌊ \frac{{N}_{BWP}^{size}}{4} ⌋$ | $⌊ \frac{{N}_{SB}^{size}}{4} ⌋$ |
| | 10 | $- ⌊ \frac{{N}_{BWP}^{size}}{4} ⌋$ | $- ⌊ \frac{{N}_{SB}^{size}}{4} ⌋$ |
| | 11 | Reserved | Reserved or |
| | | | $- ⌊ \frac{{N}_{SB}^{size}}{2} ⌋$ |

The UE may indicate support for a configuration (such as, the second configuration) via capability information, or an early indication as described herein. In such examples, a starting RB 520-a in non-SBFD symbols may be determined according to an FDRA in a DCI message, and one or more frequency hopping offsets (such as, the frequency hopping offset 525).

In some examples, the starting RB 520-b in an SBFD slot may be determined to be the same, or may be determined in the same way, as a starting RB 520-a in non-SBFD symbols. In some examples, the starting RB 520-b in the SBFD slots may be identified according to n implicit offset (such as, an offset 525). The offset 525 may be based on an uplink subband size, a starting or a last uplink useable PRB, or the like, may be used to determine the starting RB 520-b in the SBFD symbols according to equation 2:

$${B}_{start} ( S B F D ) = R {B}_{start} + R {B}_{offset} \qquad Equation 2$$

In some examples, the RB 520-b may be identified using a modular operation according to a size of an uplink BWP, or a quantity of useable PRBs of a sum of the determined RB offset (such as, the offset 525) and the starting RB indicated by the FDRA according to Equation 2:

$$R {B}_{start} ( SBFD ) = ( R {B}_{start} + R {B}_{offset} ) mod {N}_{B W P}^{s i z e} or \qquad Equation 2$$

$${RB}_{start} ( S B F D ) = ( {RB}_{start} + R {B}_{offset} ) mod {N}_{S B}^{s i z e}$$

In some examples, the starting RB 520-b for SBFD symbols may be explicitly indicated within a feature combination. In some cases, a starting RB 520-b may be determined with respect to a lowest useable PRB in an uplink subband, or a PRBO of an uplink BWP.

When the frequency hopping is enabled for the second configuration, the UE may determine that frequency hopping is applied for non-SBFD repetition only, and is disabled in SBFD symbols (such as, as indicated by the control signaling indicating the second configuration, or according to one or more rules associated with the indication of the second configuration). In some examples, when the frequency hopping is enabled for the second configuration, the UE may determine that frequency hopping is applied for both non-SBFD repetitions and SBFD repetitions (such as, as indicated by the control signaling indicating the second configuration, or according to one or more rules associated with the indication of the second configuration). The enabled frequency hopping and techniques described with reference to FIG. 5 may support effective frequency hopping by the UE 115-b. Without techniques described herein, the UE 115-b may be unable to effectively identify a starting RB, or one or more frequency hops based on the starting RB in SBFD slots 535. By implementing techniques described herein, the UE 115-b may be able to support frequency hopping for increased frequency diversity and more reliable uplink repetitions in SBFD and non-SBFD slots.

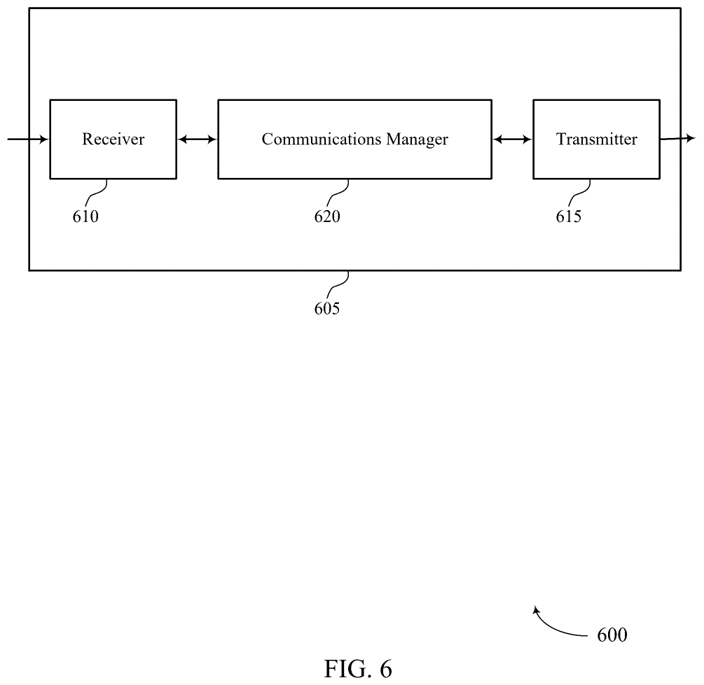

FIG. 6 shows a block diagram 600 of a device 605 that supports uplink message repetitions for SBFD-aware devices. The device 605 may be an example of aspects of a UE 115 as described herein. The device 605 may include a receiver 610, a transmitter 615, and a communications manager 620. The device 605, or one or more components of the device 605 (such as, the receiver 610, the transmitter 615, the communications manager 620), may include at least one processor, which may be coupled with at least one memory, to, individually or collectively, support or enable the described techniques. Each of these components may be in communication with one another (such as, via one or more buses).

The receiver 610 may provide a means for receiving information such as packets, user data, control information, or any combination thereof associated with various information channels (such as, control channels, data channels, information channels related to uplink message repetitions for SBFD-aware devices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (such as, control channels, data channels, information channels related to uplink message repetitions for SBFD-aware devices). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of uplink message repetitions for SBFD-aware devices as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (such as, in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as, by one or more processors, individually or collectively, executing instructions stored in the at least one memory).

Additionally, or alternatively, the communications manager 620, the receiver 610, the transmitter 615, or various combinations or components thereof may be implemented in code (such as, as communications management software or firmware) executed by at least one processor (such as, referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (such as, configured as or otherwise supporting, individually or collectively, a means for performing the functions described in the present disclosure).

In some examples, the communications manager 620 may be configured to perform various operations (such as, receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation. The communications manager 620 is capable of, configured to, or operable to support a means for receiving second control signaling indicating a first configuration or a second configuration, where the first configuration supports wireless communications via the first type of symbols or the second type of symbols, and where the second configuration supports wireless communications via both the first type of symbols and the second type of symbols. The communications manager 620 is capable of, configured to, or operable to support a means for transmitting one or more repetitions of an uplink message via one or more uplink occasions of the first set of uplink occasions, via one or more uplink occasions of the second set of uplink occasions, or both, where the one or more uplink occasions of the first set of uplink occasions, the one or more uplink occasions of the second set of uplink occasions, or both are selected in accordance with a slot counting procedure in which one or more slots are counted, where the slot counting procedure is based on the first configuration or the second configuration.

By including or configuring the communications manager 620 in accordance with examples as described herein, the device 605 (such as, at least one processor controlling or otherwise coupled with the receiver 610, the transmitter 615, the communications manager 620, or a combination thereof) may support techniques for uplink repetition and resource selection resulting in reduced processing, reduced power consumption, more efficient utilization of communication resources, and reduced system latency.

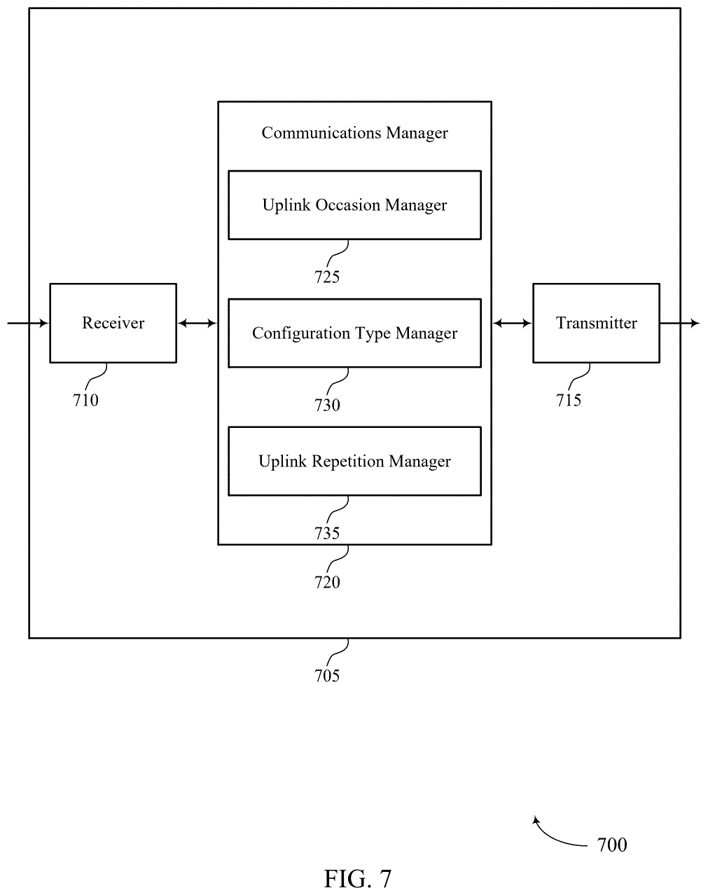

FIG. 7 shows a block diagram 700 of a device 705 that supports uplink message repetitions for SBFD-aware devices. The device 705 may be an example of aspects of a device 605 or a UE 115 as described herein. The device 705 may include a receiver 710, a transmitter 715, and a communications manager 720. The device 705, or one of more components of the device 705 (such as, the receiver 710, the transmitter 715, the communications manager 720), may include at least one processor, which may be coupled with at least one memory, to support the described techniques. Each of these components may be in communication with one another (such as, via one or more buses).

The receiver 710 may provide a means for receiving information such as packets, user data, control information, or any combination thereof associated with various information channels (such as, control channels, data channels, information channels related to uplink message repetitions for SBFD-aware devices). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (such as, control channels, data channels, information channels related to uplink message repetitions for SBFD-aware devices). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of uplink message repetitions for SBFD-aware devices as described herein. For example, the communications manager 720 may include an uplink occasion manager 725, a configuration type manager 730, an uplink repetition manager 735, or any combination thereof. The communications manager 720 may be an example of aspects of a communications manager 620 as described herein. In some examples, the communications manager 720, or various components thereof, may be configured to perform various operations (such as, receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The uplink occasion manager 725 is capable of, configured to, or operable to support a means for receiving first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation. The configuration type manager 730 is capable of, configured to, or operable to support a means for receiving second control signaling indicating a first configuration or a second configuration, where the first configuration supports wireless communications via the first type of symbols or the second type of symbols, and where the second configuration supports wireless communications via both the first type of symbols and the second type of symbols. The uplink repetition manager 735 is capable of, configured to, or operable to support a means for transmitting one or more repetitions of an uplink message via one or more uplink occasions of the first set of uplink occasions, via one or more uplink occasions of the second set of uplink occasions, or both, where the one or more uplink occasions of the first set of uplink occasions, the one or more uplink occasions of the second set of uplink occasions, or both are selected in accordance with a slot counting procedure in which one or more slots are counted, where the slot counting procedure is based on the first configuration or the second configuration.

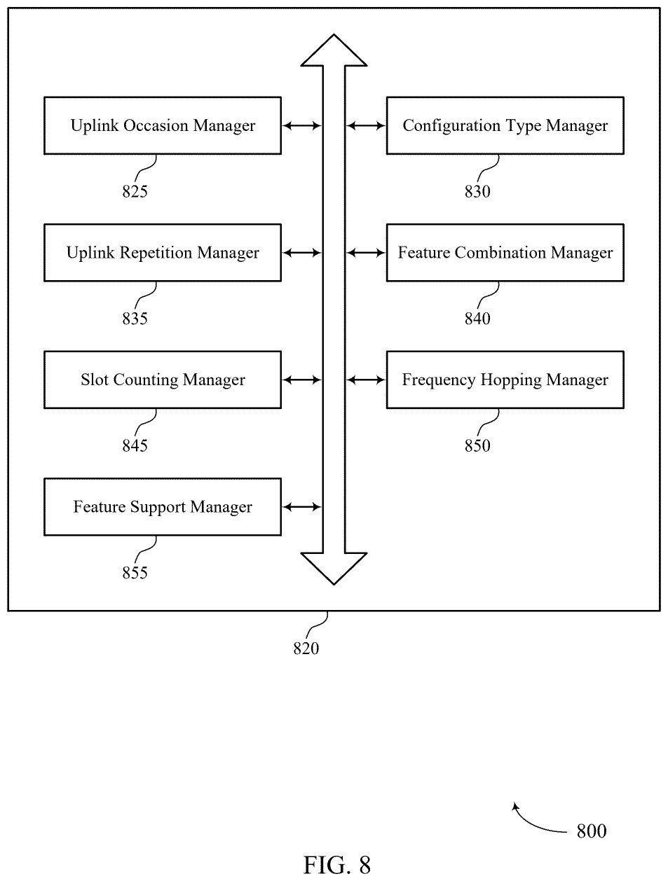

FIG. 8 shows a block diagram 800 of a communications manager 820 that supports uplink message repetitions for SBFD-aware devices. The communications manager 820 may be an example of aspects of a communications manager 620, a communications manager 720, or both, as described herein. The communications manager 820, or various components thereof, may be an example of means for performing various aspects of uplink message repetitions for SBFD-aware devices as described herein. For example, the communications manager 820 may include an uplink occasion manager 825, a configuration type manager 830, an uplink repetition manager 835, a feature combination manager 840, a slot counting manager 845, a frequency hopping manager 850, a feature support manager 855, or any combination thereof. Each of these components, or components or subcomponents thereof (such as, one or more processors, one or more memories), may communicate, directly or indirectly, with one another (such as, via one or more buses).

The communications manager 820 may support wireless communications in accordance with examples as disclosed herein. The uplink occasion manager 825 is capable of, configured to, or operable to support a means for receiving first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation. The configuration type manager 830 is capable of, configured to, or operable to support a means for receiving second control signaling indicating a first configuration or a second configuration, where the first configuration supports wireless communications via the first type of symbols or the second type of symbols, and where the second configuration supports wireless communications via both the first type of symbols and the second type of symbols. The uplink repetition manager 835 is capable of, configured to, or operable to support a means for transmitting one or more repetitions of an uplink message via one or more uplink occasions of the first set of uplink occasions, via one or more uplink occasions of the second set of uplink occasions, or both, where the one or more uplink occasions of the first set of uplink occasions, the one or more uplink occasions of the second set of uplink occasions, or both are selected in accordance with a slot counting procedure in which one or more slots are counted, where the slot counting procedure is based on the first configuration or the second configuration.

In some examples, to support receiving the second control signaling, the feature combination manager 840 is capable of, configured to, or operable to support a means for receiving a feature combination message indicating support of repetitions of the uplink message, and indicating a first subset of random access resources of a set of multiple candidate random access resources, the first subset of random access resources corresponding to the supported repetitions of the uplink message, where the one or more repetitions of the uplink message are transmitted based on receiving the feature combination message.

In some examples, the feature combination message indicates that repetition of the uplink message is supported via the first type of symbols or the second type of symbols in accordance with the first configuration.

In some examples, the feature combination message indicates that repetitions of the uplink message is supported via both the first type of symbols and the second type of symbols in accordance with the second configuration.

In some examples, the feature support manager 855 is capable of, configured to, or operable to support a means for transmitting a random access preamble via a random access resource of the first subset of random access resources, the random access preamble transmitted via the random access resource indicating that the UE supports repetitions of the uplink message via the second type of symbols or the first type of symbols in accordance with the first configuration, or via both the first type of symbols and the second type of symbols in accordance with the second configuration, where the one or more repetitions of the uplink message are transmitted based on transmitting the random access preamble.

In some examples, the slot counting manager 845 is capable of, configured to, or operable to support a means for receiving a random access message triggering the uplink message. In some examples, the slot counting manager 845 is capable of, configured to, or operable to support a means for selecting a first uplink occasion of the one or more uplink occasions of the first set of uplink occasions, the one or more uplink occasions of the second set of uplink occasions, or both based on a validity of one or more symbols of the first uplink occasion and in accordance with the slot counting procedure, where the validity of the one or more symbols is based on an indication in the random access message, a reference slot type indicated via the second control signaling, a symbol type corresponding to the symbol via which the random access message is received, or any combination thereof.

In some examples, the slot counting manager 845 is capable of, configured to, or operable to support a means for receiving a random access message triggering the uplink message. In some examples, the slot counting manager 845 is capable of, configured to, or operable to support a means for selecting a first uplink occasion of the one or more uplink occasions of the first set uplink occasions, the second set of uplink occasions, or both based on a validity of one or more symbols of the first uplink occasion and in accordance with the slot counting procedure, the first uplink occasion occurring in a slot that includes a first subset of the first type of symbols and a second subset of the second type of symbols, where the validity of the one or more symbols is based on a time domain resource allocation in the random access message, a symbol type of a first in time symbol of the slot, a default type of symbol including the second type of symbol, or any combination thereof.

In some examples, the slot counting manager 845 is capable of, configured to, or operable to support a means for receiving a control message indicating a quantity of the one or more repetitions for the uplink message. In some examples, the slot counting manager 845 is capable of, configured to, or operable to support a means for selecting the one or more uplink occasions of the first set of uplink occasions, the one or more uplink occasions of the second set of uplink occasions, or both according to the slot counting procedure from slots that include the first type of symbols and do not include the second type of symbols in accordance with the control message and the first configuration.

In some examples, the slot counting manager 845 is capable of, configured to, or operable to support a means for receiving a control message indicating a quantity of the one or more repetitions for the uplink message and a slot offset value indicating a reference slot for a first uplink occasion of the one or more uplink occasions of the first set of uplink occasions, the second set of uplink occasions, or both. In some examples, the slot counting manager 845 is capable of, configured to, or operable to support a means for selecting the one or more uplink occasions of the first set of uplink occasions, the one or more uplink occasions of the second set of uplink occasions, or both based on a physical slot counting procedure, the first uplink occasion of the one or more uplink occasions of the first set of uplink occasions, the second set of uplink occasions, or both located in the reference slot indicated by the slot offset value.

In some examples, the slot counting manager 845 is capable of, configured to, or operable to support a means for selecting the one or more uplink occasions in accordance with the first configuration and a validity of a set of multiple slots. In some examples, the slot counting manager 845 is capable of, configured to, or operable to support a means for refraining from selecting one or more additional uplink occasions according to the slot counting procedure in response to the one or more additional uplink occasions including the first type of uplink occasion, or in response to a slot including an uplink occasion further including one or more symbols overlapping in time with a synchronization signal block.

In some examples, the slot counting manager 845 is capable of, configured to, or operable to support a means for selecting the one or more uplink occasions in accordance with the first configuration and a validity of a set of multiple slots. In some examples, the slot counting manager 845 is capable of, configured to, or operable to support a means for refraining from selecting one or more additional uplink occasions according to the slot counting procedure in response to the one or more additional uplink occasions including the second type of uplink occasion, in response to a slot corresponding to an uplink occasion including both the first type of symbol and the second type of symbol, or in response to the slot corresponding to the uplink occasion including one or more symbols overlapping in time with a synchronization signal block.

In some examples, the slot counting manager 845 is capable of, configured to, or operable to support a means for selecting the one or more uplink occasions of the first set of uplink occasions, the second set of uplink occasions, or both in accordance with the second configuration and a validity of a set of multiple slots according to the slot counting procedure. In some examples, the slot counting manager 845 is capable of, configured to, or operable to support a means for refraining from selecting one or more additional uplink occasions according to the slot counting procedure in response to the one or more additional uplink occasions being located within downlink slots, or in response to an uplink occasion being located within a slot that includes both the first type of symbols and the second type of symbols, or in response to the slot corresponding to the uplink occasion including one or more symbols overlapping in time with a synchronization signal block.

In some examples, to support receiving the second control signaling, the feature combination manager 840 is capable of, configured to, or operable to support a means for receiving system information including a feature combination information element including an indication of the first configuration or the second configuration.

In some examples, to support receiving the second control signaling, the configuration type manager 830 is capable of, configured to, or operable to support a means for receiving a random access response message including a MAC control element (CE), the MAC-CE indicating the first configuration or the second configuration.

In some examples, to support receiving the second control signaling, the configuration type manager 830 is capable of, configured to, or operable to support a means for receiving a downlink control information message, a field in the downlink control information message including an indication of the first configuration or the second configuration.

In some examples, the frequency hopping manager 850 is capable of, configured to, or operable to support a means for receiving a downlink control information message triggering transmission of the uplink message, the downlink control information message including a frequency hopping offset for repetitions of the uplink message, where the one or more repetitions of the uplink message are transmitted in accordance with the frequency hopping offset, and where the frequency hopping offset is based on a subband corresponding to the uplink message and the one or more uplink occasions.

In some examples, the one or more repetitions of the uplink message include one or more repetitions of a random access message.

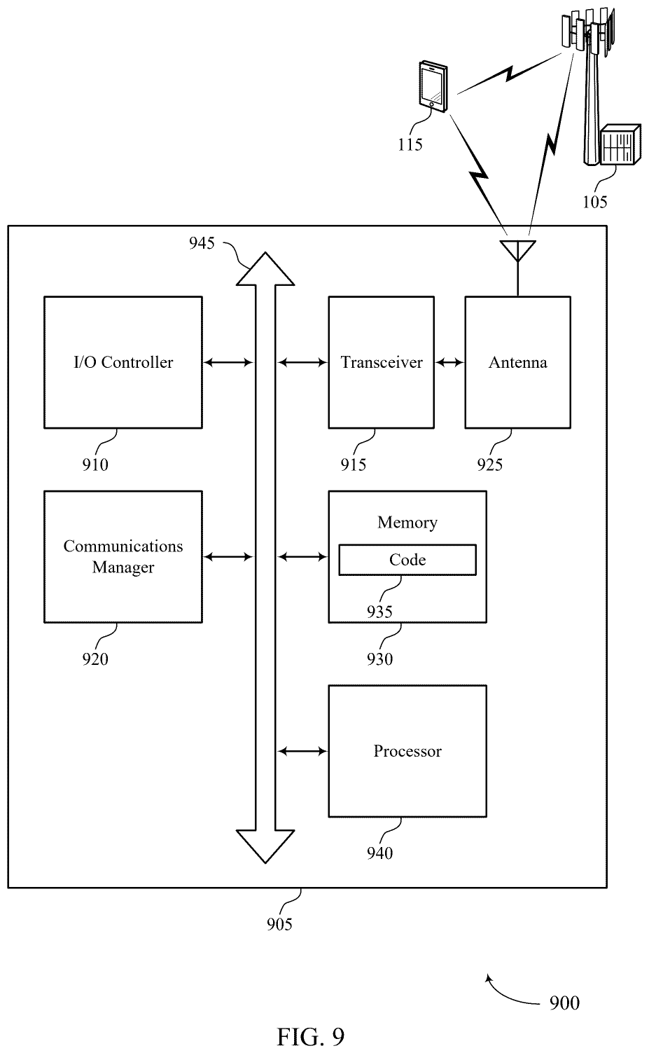

FIG. 9 shows a diagram of a system 900 including a device 905 that supports uplink message repetitions for SBFD-aware devices. The device 905 may be an example of or include components of a device 605, a device 705, or a UE 115 as described herein. The device 905 may communicate (such as, wirelessly) with one or more other devices (such as, network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (such as, operatively, communicatively, functionally, electronically, electrically) via one or more buses (such as, a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (such as, when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (such as, one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (such as, the at least one memory 930) to cause the device 905 to perform various functions (such as, functions or tasks supporting uplink message repetitions for SBFD-aware devices). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (such as, processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation. The communications manager 920 is capable of, configured to, or operable to support a means for receiving second control signaling indicating a first configuration or a second configuration, where the first configuration supports wireless communications via the first type of symbols or the second type of symbols, and where the second configuration supports wireless communications via both the first type of symbols and the second type of symbols. The communications manager 920 is capable of, configured to, or operable to support a means for transmitting one or more repetitions of an uplink message via one or more uplink occasions of the first set of uplink occasions, via one or more uplink occasions of the second set of uplink occasions, or both, where the one or more uplink occasions of the first set of uplink occasions, the one or more uplink occasions of the second set of uplink occasions, or both are selected in accordance with a slot counting procedure in which one or more slots are counted, where the slot counting procedure is based on the first configuration or the second configuration.

By including or configuring the communications manager 920 in accordance with examples as described herein, the device 905 may support techniques for uplink repetition and resource selection resulting in reduced processing, reduced power consumption, more efficient utilization of communication resources, improved coordination between devices, longer battery life, improved throughput, and reduced system latency.

In some examples, the communications manager 920 may be configured to perform various operations (such as, receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of uplink message repetitions for SBFD-aware devices as described herein, or the at least one processor 940 and the at least one memory 930 may be otherwise configured to, individually or collectively, perform or support such operations.

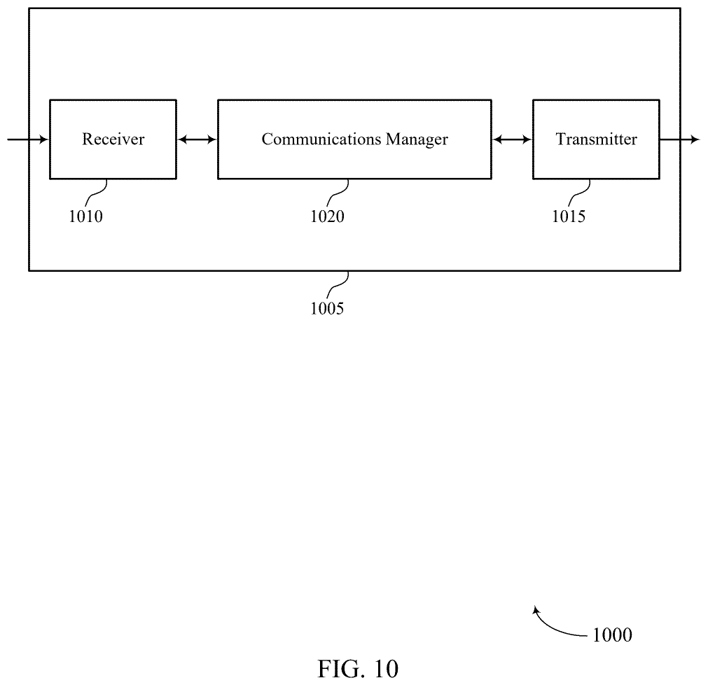

FIG. 10 shows a block diagram 1000 of a device 1005 that supports uplink message repetitions for SBFD-aware devices. The device 1005 may be an example of aspects of a network entity 105 as described herein. The device 1005 may include a receiver 1010, a transmitter 1015, and a communications manager 1020. The device 1005, or one or more components of the device 1005 (such as, the receiver 1010, the transmitter 1015, the communications manager 1020), may include at least one processor, which may be coupled with at least one memory, to, individually or collectively, support or enable the described techniques. Each of these components may be in communication with one another (such as, via one or more buses).

The receiver 1010 may provide a means for obtaining (such as, receiving, determining, identifying) information such as user data, control information, or any combination thereof (such as, I/Q samples, symbols, packets, protocol data units, service data units) associated with various channels (such as, control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (such as, electrical, fiber optic) interfaces, wireless interfaces, or any combination thereof.

The transmitter 1015 may provide a means for outputting (such as, transmitting, providing, conveying, sending) information generated by other components of the device 1005. For example, the transmitter 1015 may output information such as user data, control information, or any combination thereof (such as, I/Q samples, symbols, packets, protocol data units, service data units) associated with various channels (such as, control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (such as, electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of uplink message repetitions for SBFD-aware devices as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (such as, in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as, by one or more processors, individually or collectively, executing instructions stored in the at least one memory).

Additionally, or alternatively, the communications manager 1020, the receiver 1010, the transmitter 1015, or various combinations or components thereof may be implemented in code (such as, as communications management software or firmware) executed by at least one processor (such as, referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (such as, configured as or otherwise supporting, individually or collectively, a means for performing the functions described in the present disclosure).

In some examples, the communications manager 1020 may be configured to perform various operations (such as, receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for transmitting first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation. The communications manager 1020 is capable of, configured to, or operable to support a means for transmitting second control signaling indicating a first configuration or a second configuration, where the first configuration supports wireless communications via the first type of symbols or the second type of symbols, and where the second configuration supports wireless communications via both the first type of symbols and the second type of symbols. The communications manager 1020 is capable of, configured to, or operable to support a means for receiving one or more repetitions of an uplink message via one or more uplink occasions of the first set of uplink occasions, one or more uplink occasions of the second set of uplink occasions, or both, where the one or more uplink occasions of the first set of uplink occasions, the one or more uplink occasions of the second set of uplink occasions, or both are based on a slot counting procedure in which one or more slots are counted, where the slot counting procedure is based on the first configuration or the second configuration.

By including or configuring the communications manager 1020 in accordance with examples as described herein, the device 1005 (such as, at least one processor controlling or otherwise coupled with the receiver 1010, the transmitter 1015, the communications manager 1020, or a combination thereof) may support techniques for uplink repetition and resource selection resulting in reduced processing, reduced power consumption, more efficient utilization of communication resources, and reduced system latency.

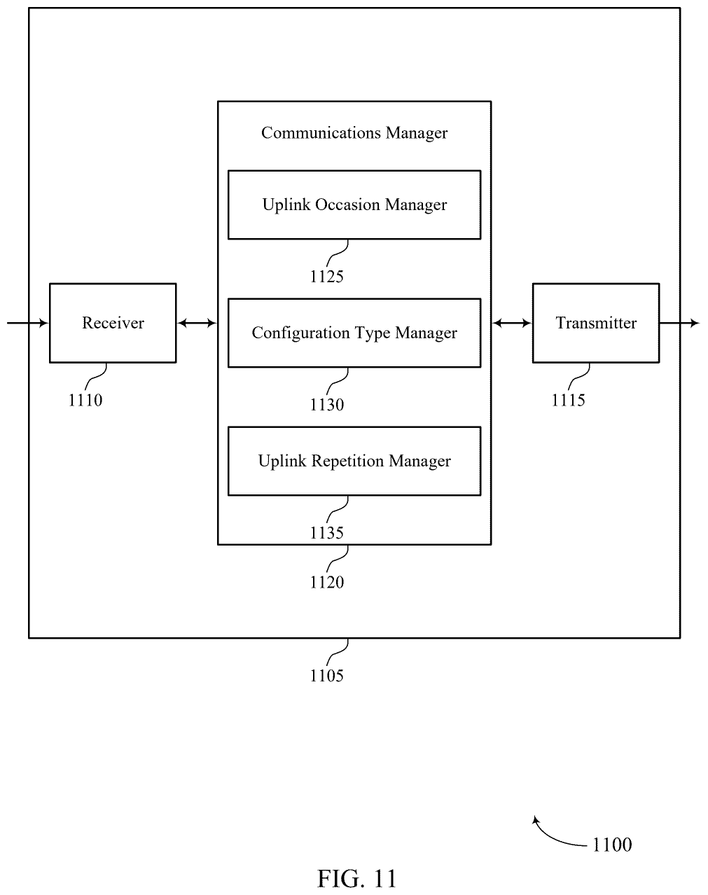

FIG. 11 shows a block diagram 1100 of a device 1105 that supports uplink message repetitions for SBFD-aware devices. The device 1105 may be an example of aspects of a device 1005 or a network entity 105 as described herein. The device 1105 may include a receiver 1110, a transmitter 1115, and a communications manager 1120. The device 1105, or one of more components of the device 1105 (such as, the receiver 1110, the transmitter 1115, the communications manager 1120), may include at least one processor, which may be coupled with at least one memory, to support the described techniques. Each of these components may be in communication with one another (such as, via one or more buses).

The receiver 1110 may provide a means for obtaining (such as, receiving, determining, identifying) information such as user data, control information, or any combination thereof (such as, I/Q samples, symbols, packets, protocol data units, service data units) associated with various channels (such as, control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (such as, electrical, fiber optic) interfaces, wireless interfaces, or any combination thereof.

The transmitter 1115 may provide a means for outputting (such as, transmitting, providing, conveying, sending) information generated by other components of the device 1105. For example, the transmitter 1115 may output information such as user data, control information, or any combination thereof (such as, I/Q samples, symbols, packets, protocol data units, service data units) associated with various channels (such as, control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (such as, electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of uplink message repetitions for SBFD-aware devices as described herein. For example, the communications manager 1120 may include an uplink occasion manager 1125, a configuration type manager 1130, an uplink repetition manager 1135, or any combination thereof. The communications manager 1120 may be an example of aspects of a communications manager 1020 as described herein. In some examples, the communications manager 1120, or various components thereof, may be configured to perform various operations (such as, receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The uplink occasion manager 1125 is capable of, configured to, or operable to support a means for transmitting first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation. The configuration type manager 1130 is capable of, configured to, or operable to support a means for transmitting second control signaling indicating a first configuration or a second configuration, where the first configuration supports wireless communications via the first type of symbols or the second type of symbols, and where the second configuration supports wireless communications via both the first type of symbols and the second type of symbols. The uplink repetition manager 1135 is capable of, configured to, or operable to support a means for receiving one or more repetitions of an uplink message via one or more uplink occasions of the first set of uplink occasions, one or more uplink occasions of the second set of uplink occasions, or both, where the one or more uplink occasions of the first set of uplink occasions, the one or more uplink occasions of the second set of uplink occasions, or both are based on a slot counting procedure in which one or more slots are counted, where the slot counting procedure is based on the first configuration or the second configuration.

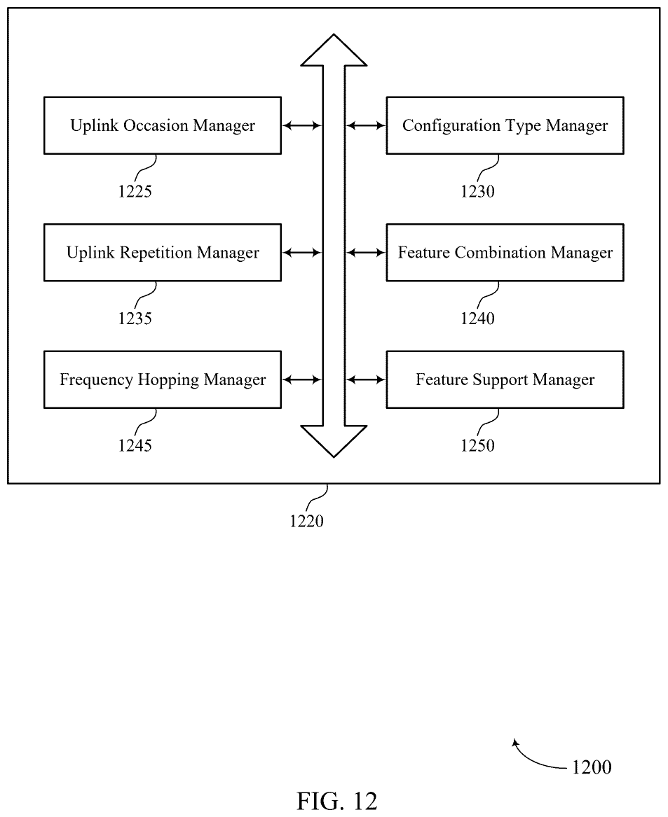

FIG. 12 shows a block diagram 1200 of a communications manager 1220 that supports uplink message repetitions for SBFD-aware devices. The communications manager 1220 may be an example of aspects of a communications manager 1020, a communications manager 1120, or both, as described herein. The communications manager 1220, or various components thereof, may be an example of means for performing various aspects of uplink message repetitions for SBFD-aware devices as described herein. For example, the communications manager 1220 may include an uplink occasion manager 1225, a configuration type manager 1230, an uplink repetition manager 1235, a feature combination manager 1240, a frequency hopping manager 1245, a feature support manager 1250, or any combination thereof. Each of these components, or components or subcomponents thereof (such as, one or more processors, one or more memories), may communicate, directly or indirectly, with one another (such as, via one or more buses). The communications may include communications within a protocol layer of a protocol stack, communications associated with a logical channel of a protocol stack (such as, between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The uplink occasion manager 1225 is capable of, configured to, or operable to support a means for transmitting first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation. The configuration type manager 1230 is capable of, configured to, or operable to support a means for transmitting second control signaling indicating a first configuration or a second configuration, where the first configuration supports wireless communications via the first type of symbols or the second type of symbols, and where the second configuration supports wireless communications via both the first type of symbols and the second type of symbols. The uplink repetition manager 1235 is capable of, configured to, or operable to support a means for receiving one or more repetitions of an uplink message via one or more uplink occasions of the first set of uplink occasions, one or more uplink occasions of the second set of uplink occasions, or both, where the one or more uplink occasions of the first set of uplink occasions, the one or more uplink occasions of the second set of uplink occasions, or both are based on a slot counting procedure in which one or more slots are counted, where the slot counting procedure is based on the first configuration or the second configuration.

In some examples, to support transmitting the second control signaling, the feature combination manager 1240 is capable of, configured to, or operable to support a means for transmitting a feature combination message indicating support of repetitions of the uplink message, and indicating a first subset of random access resources of a set of multiple candidate random access resources, the first subset of random access resources corresponding to the supported repetitions of the uplink message, where receiving the one or more repetitions of the uplink message is based on transmitting the feature combination message.

In some examples, the feature combination message indicates that repetition of the uplink message is supported via the first type of symbols or the second type of symbols in accordance with the first configuration.

In some examples, the feature combination message indicates that repetitions of the uplink message is supported via both the first type of symbols and the second type of symbols in accordance with the second configuration.

In some examples, the feature support manager 1250 is capable of, configured to, or operable to support a means for receiving a random access preamble via a random access resource of the first subset of random access resources, the random access preamble received via the random access resource indicating that the UE supports repetitions of the uplink message via the second type of symbols or the first type of symbols in accordance with the first configuration, or via both the first type of symbols and the second type of symbols in accordance with the second configuration, where receiving the one or more repetitions of the uplink message is based on receiving the random access preamble.

In some examples, to support transmitting the second control signaling, the feature combination manager 1240 is capable of, configured to, or operable to support a means for transmitting system information including a feature combination information element including an indication of the first configuration or the second configuration.

In some examples, to support transmitting the second control signaling, the configuration type manager 1230 is capable of, configured to, or operable to support a means for transmitting a random access response message including a MAC control element (CE), the MAC-CE indicating the first configuration or the second configuration.

In some examples, to support transmitting the second control signaling, the configuration type manager 1230 is capable of, configured to, or operable to support a means for transmitting a downlink control information message, a field in the downlink control information message including an indication of the first configuration or the second configuration.

In some examples, the frequency hopping manager 1245 is capable of, configured to, or operable to support a means for transmitting a downlink control information message triggering transmission of the uplink message, the downlink control information message including a frequency hopping offset for repetitions of the uplink message, where receiving the one or more repetitions of the uplink message is in accordance with the frequency hopping offset, and where the frequency hopping offset is based on a subband corresponding to the uplink message and the one or more uplink occasions.

In some examples, the one or more repetitions of the uplink message include one or more repetitions of a random access message.

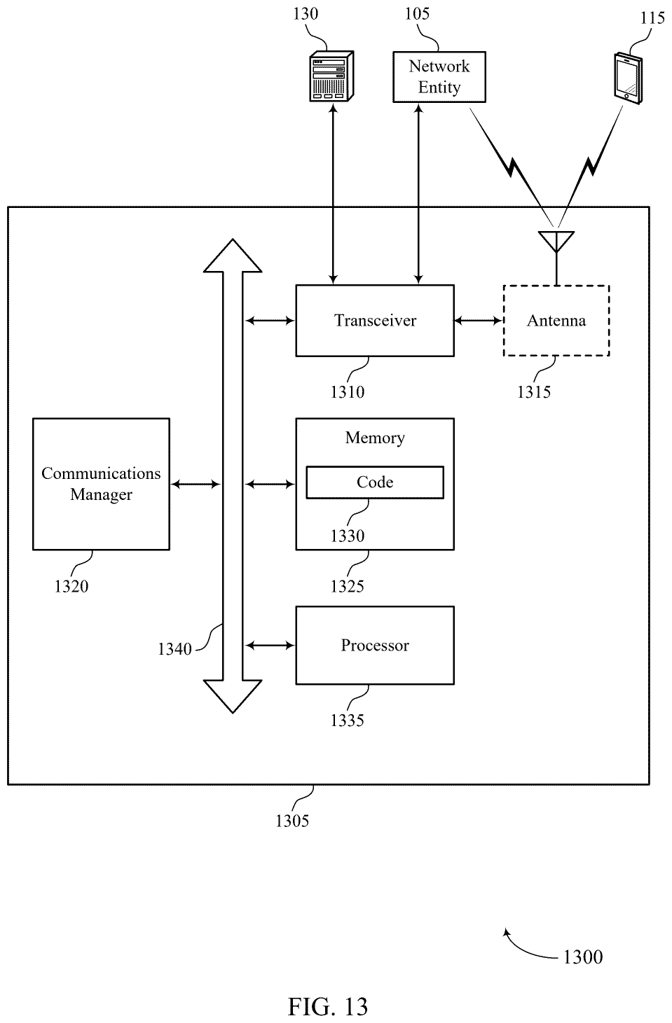

FIG. 13 shows a diagram of a system 1300 including a device 1305 that supports uplink message repetitions for SBFD-aware devices. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (such as, operatively, communicatively, functionally, electronically, electrically) via one or more buses (such as, a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (such as, concurrently). The transceiver 1310 may also include a modem to modulate signals, to provide the modulated signals for transmission (such as, by one or more antennas 1315, by a wired transmitter), to receive modulated signals (such as, from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (such as, the at least one processor 1335, the at least one memory 1325, or both), may be included in a chip or chip assembly that is installed in the device 1305. In some examples, the transceiver 1310 may be operable to support communications via one or more communications links (such as, communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (such as, when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (such as, one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (such as, one or more of the at least one memory 1325) to cause the device 1305 to perform various functions (such as, functions or tasks supporting uplink message repetitions for SBFD-aware devices). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (such as, one or more physical nodes and supporting software such as operating systems, virtual machines, or container instances) that may host the functions (such as, by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (such as, within) a protocol layer of a protocol stack. In some examples, a bus 1340 may support communications associated with a logical channel of a protocol stack (such as, between protocol layers of a protocol stack), which may include communications performed within a component of the device 1305, or between different components of the device 1305 that may be co-located or located in different locations (such as, where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (such as, via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (such as, in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for transmitting first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation. The communications manager 1320 is capable of, configured to, or operable to support a means for transmitting second control signaling indicating a first configuration or a second configuration, where the first configuration supports wireless communications via the first type of symbols or the second type of symbols, and where the second configuration supports wireless communications via both the first type of symbols and the second type of symbols. The communications manager 1320 is capable of, configured to, or operable to support a means for receiving one or more repetitions of an uplink message via one or more uplink occasions of the first set of uplink occasions, one or more uplink occasions of the second set of uplink occasions, or both, where the one or more uplink occasions are of the first set of uplink occasions, the one or more uplink occasions of the second set of uplink occasions, or both are based on a slot counting procedure in which one or more slots are counted, where the slot counting procedure is based on the first configuration or the second configuration.

By including or configuring the communications manager 1320 in accordance with examples as described herein, the device 1305 may support techniques for uplink repetition and resource selection resulting in reduced processing, reduced power consumption, more efficient utilization of communication resources, improved coordination between devices, longer battery life, improved throughput, and reduced system latency.

In some examples, the communications manager 1320 may be configured to perform various operations (such as, receiving, obtaining, monitoring, outputting, transmitting) using or otherwise in cooperation with the transceiver 1310, the one or more antennas 1315 (such as, where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of uplink message repetitions for SBFD-aware devices as described herein, or the at least one processor 1335 and the at least one memory 1325 may be otherwise configured to, individually or collectively, perform or support such operations.

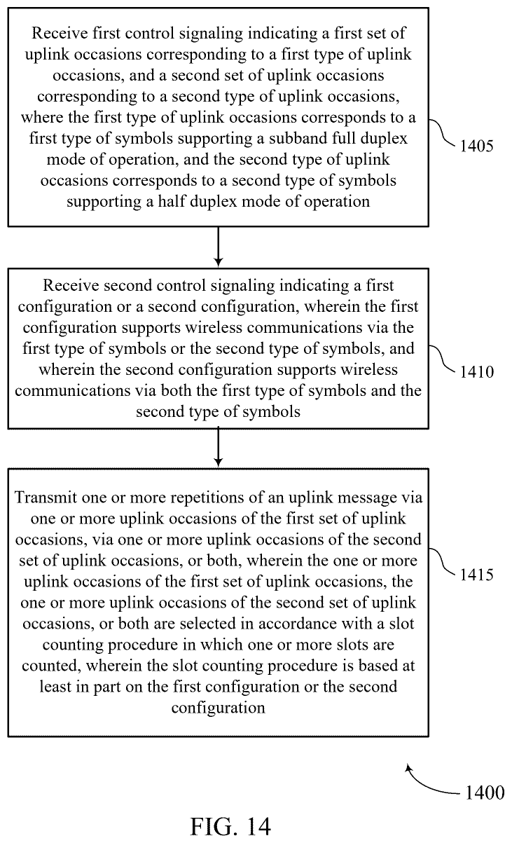

FIG. 14 shows a flowchart illustrating a method 1400 that supports uplink message repetitions for SBFD-aware devices. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation. The operations of 1405 may be performed in accordance with examples as disclosed herein. In some examples, aspects of the operations of 1405 may be performed by an uplink occasion manager 825 as described with reference to FIG. 8.

At 1410, the method may include receiving second control signaling indicating a first configuration or a second configuration, where the first configuration supports wireless communications via the first type of symbols or the second type of symbols, and where the second configuration supports wireless communications via both the first type of symbols and the second type of symbols. The operations of 1410 may be performed in accordance with examples as disclosed herein. In some examples, aspects of the operations of 1410 may be performed by a configuration type manager 830 as described with reference to FIG. 8.

At 1415, the method may include transmitting one or more repetitions of an uplink message via one or more uplink occasions of the first set of uplink occasions, via one or more uplink occasions of the second set of uplink occasions, or both, where the one or more uplink occasions of the first set of uplink occasions, the one or more uplink occasions of the second set of uplink occasions, are both are selected in accordance with a slot counting procedure in which one or more slots are counted, where the slot counting procedure is based on the first configuration or the second configuration. The operations of 1415 may be performed in accordance with examples as disclosed herein. In some examples, aspects of the operations of 1415 may be performed by an uplink repetition manager 835 as described with reference to FIG. 8.

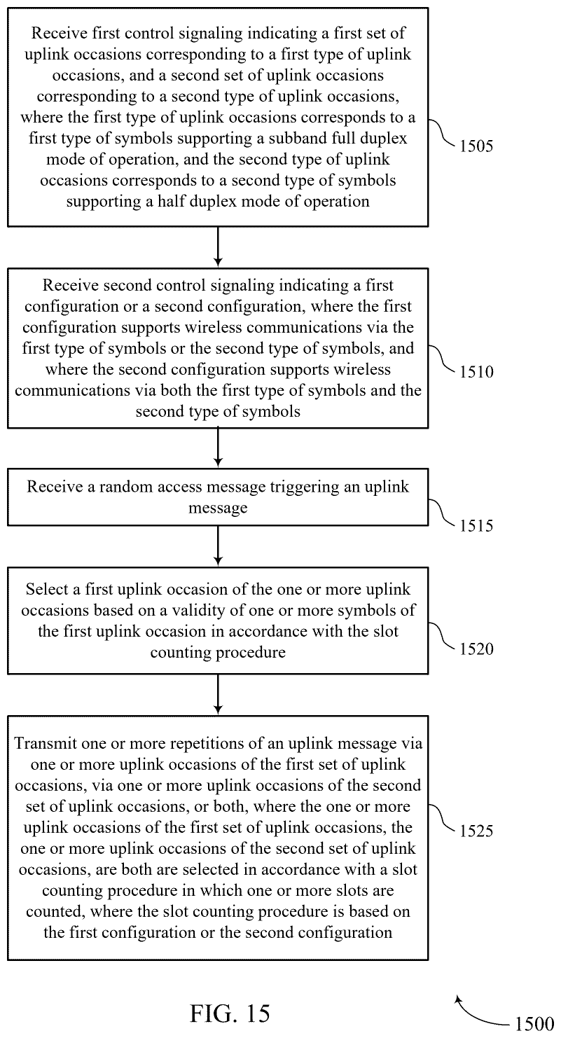

FIG. 15 shows a flowchart illustrating a method 1500 that supports uplink message repetitions for SBFD-aware devices. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation. The operations of 1505 may be performed in accordance with examples as disclosed herein. In some examples, aspects of the operations of 1505 may be performed by an uplink occasion manager 825 as described with reference to FIG. 8.

At 1510, the method may include receiving second control signaling indicating a first configuration or a second configuration, where the first configuration supports wireless communications via the first type of symbols or the second type of symbols, and where the second configuration supports wireless communications via both the first type of symbols and the second type of symbols. The operations of 1510 may be performed in accordance with examples as disclosed herein. In some examples, aspects of the operations of 1510 may be performed by a configuration type manager 830 as described with reference to FIG. 8.

At 1515, the method may include receiving a random access message triggering an uplink message. The operations of 1515 may be performed in accordance with examples as disclosed herein. In some examples, aspects of the operations of 1515 may be performed by a slot counting manager 845 as described with reference to FIG. 8.

At 1520, the method may include selecting a first uplink occasion of the one or more uplink occasions based on a validity of one or more symbols of the first uplink occasion in accordance with the slot counting procedure. The operations of 1520 may be performed in accordance with examples as disclosed herein. In some examples, aspects of the operations of 1520 may be performed by a slot counting manager 845 as described with reference to FIG. 8.

At 1525, the method may include transmitting one or more repetitions of an uplink message via one or more uplink occasions of the first set of uplink occasions, via one or more uplink occasions of the second set of uplink occasions, or both, where the one or more uplink occasions of the first set of uplink occasions, the one or more uplink occasions of the second set of uplink occasions, are both are selected in accordance with a slot counting procedure in which one or more slots are counted, where the slot counting procedure is based on the first configuration or the second configuration. The operations of 1525 may be performed in accordance with examples as disclosed herein. In some examples, aspects of the operations of 1525 may be performed by an uplink repetition manager 835 as described with reference to FIG. 8.

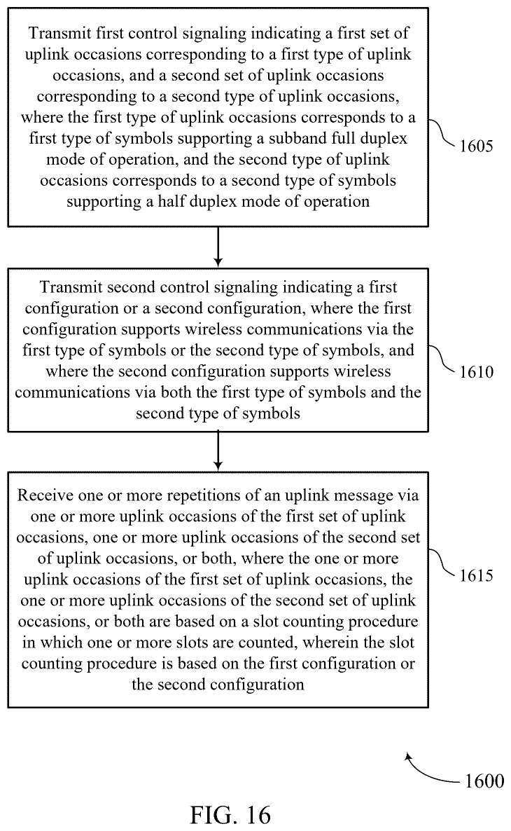

FIG. 16 shows a flowchart illustrating a method 1600 that supports uplink message repetitions for SBFD-aware devices. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation. The operations of 1605 may be performed in accordance with examples as disclosed herein. In some examples, aspects of the operations of 1605 may be performed by an uplink occasion manager 1225 as described with reference to FIG. 12.

At 1610, the method may include transmitting second control signaling indicating a first configuration or a second configuration, where the first configuration supports wireless communications via the first type of symbols or the second type of symbols, and where the second configuration supports wireless communications via both the first type of symbols and the second type of symbols. The operations of 1610 may be performed in accordance with examples as disclosed herein. In some examples, aspects of the operations of 1610 may be performed by a configuration type manager 1230 as described with reference to FIG. 12.

At 1615, the method may include receiving one or more repetitions of an uplink message via one or more uplink occasions of the first set of uplink occasions, one or more uplink occasions of the second set of uplink occasions, or both, where the one or more uplink occasions of the first set of uplink occasions, the one or more uplink occasions of the second set of uplink occasions, or both are based on a slot counting procedure in which one or more slots are counted, wherein the slot counting procedure is based on the first configuration or the second configuration. The operations of 1615 may be performed in accordance with examples as disclosed herein. In some examples, aspects of the operations of 1615 may be performed by an uplink repetition manager 1235 as described with reference to FIG. 12.

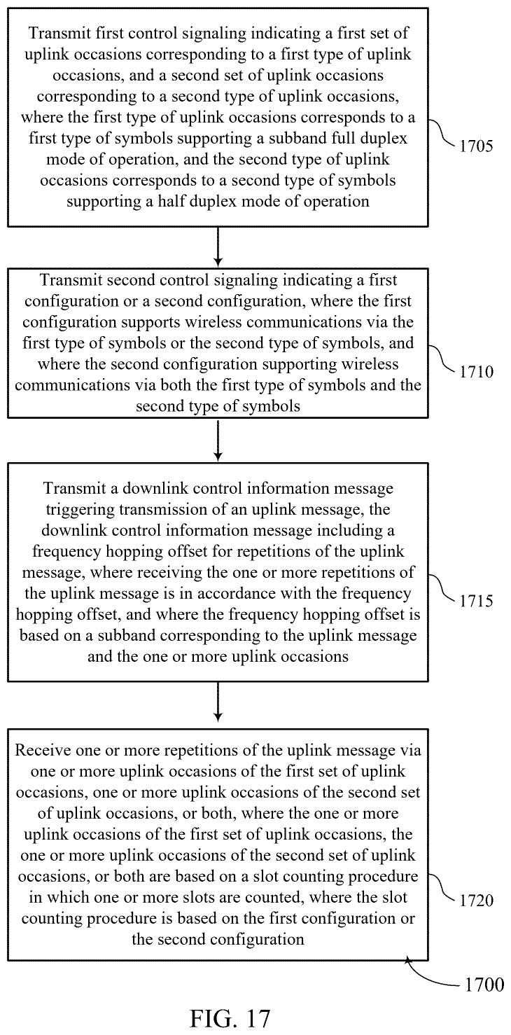

FIG. 17 shows a flowchart illustrating a method 1700 that supports uplink message repetitions for SBFD-aware devices. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting first control signaling indicating a first set of uplink occasions corresponding to a first type of uplink occasions, and a second set of uplink occasions corresponding to a second type of uplink occasions, where the first type of uplink occasions corresponds to a first type of symbols supporting a SBFD mode of operation, and the second type of uplink occasions corresponds to a second type of symbols supporting a half duplex mode of operation. The operations of 1705 may be performed in accordance with examples as disclosed herein. In some examples, aspects of the operations of 1705 may be performed by an uplink occasion manager 1225 as described with reference to FIG. 12.

At 1710, the method may include transmitting second control signaling indicating a first configuration or a second configuration, where the first configuration supports wireless communications via the first type of symbols or the second type of symbols, and where the second configuration supporting wireless communications via both the first type of symbols and the second type of symbols. The operations of 1710 may be performed in accordance with examples as disclosed herein. In some examples, aspects of the operations of 1710 may be performed by a configuration type manager 1230 as described with reference to FIG. 12.

At 1715, the method may include transmitting a downlink control information message triggering transmission of an uplink message, the downlink control information message including a frequency hopping offset for repetitions of the uplink message, where receiving the one or more repetitions of the uplink message is in accordance with the frequency hopping offset, and where the frequency hopping offset is based on a subband corresponding to the uplink message and the one or more uplink occasions. The operations of 1715 may be performed in accordance with examples as disclosed herein. In some examples, aspects of the operations of 1715 may be performed by a frequency hopping manager 1245 as described with reference to FIG. 12.

At 1720, the method may include receiving one or more repetitions of the uplink message via one or more uplink occasions of the first set of uplink occasions, one or more uplink occasions of the second set of uplink occasions, or both, where the one or more uplink occasions of the first set of uplink occasions, the one or more uplink occasions of the second set of uplink occasions, or both are based on a slot counting procedure in which one or more slots are counted, where the slot counting procedure is based on the first configuration or the second configuration. The operations of 1720 may be performed in accordance with examples as disclosed herein. In some examples, aspects of the operations of 1720 may be performed by an uplink repetition manager 1235 as described with reference to FIG. 12.

The following provides an overview of aspects of the present disclosure:
Aspect 1: A method for wireless communications at a UE, comprising: receiving first control signaling indicating a first set of uplink occasions corresponding to a first type of uplink occasions, and a second set of uplink occasions corresponding to a second type of uplink occasions, wherein the first type of uplink occasions corresponds to a first type of symbols supporting a SBFD mode of operation, and the second type of uplink occasions corresponds to a second type of symbols supporting a half duplex mode of operation; receiving second control signaling indicating a first configuration or a second configuration, where the first configuration supports wireless communications via the first type of symbols or the second type of symbols, and where the second configuration supports wireless communications via both the first type of symbols and the second type of symbols; and transmitting one or more repetitions of an uplink message via one or more uplink occasions of the first set of uplink occasions, via one or more uplink occasions of the second set of uplink occasions, or both, wherein the one or more uplink occasions are selected in accordance with a slot counting procedure wherein one or more slots are counted, where the slot counting procedure is based at least in part on the first configuration or the second configuration.
Aspect 2: The method of aspect 1, wherein receiving the second control signaling comprises: receiving a feature combination message indicating support of repetitions of the uplink message, and indicating a first subset of random access resources of a plurality of candidate random access resources, the first subset of random access resources corresponding to the supported repetitions of the uplink message, wherein the one or more repetitions of the uplink message are transmitted based at least in part on receiving the feature combination message.
Aspect 3: The method of aspect 2, wherein the feature combination message indicates that repetition of the uplink message is supported via the first type of symbols or the second type of symbols in accordance with the first configuration.
Aspect 4: The method of any of aspects 2 through 3, wherein the feature combination message indicates that repetitions of the uplink message is supported via both the first type of symbols and the second type of symbols in accordance with the second configuration.
Aspect 5: The method of any of aspects 2 through 4, further comprising: transmitting a random access preamble via a random access resource of the first subset of random access resources, the random access preamble transmitted via the random access resource indicating that the UE supports repetitions of the uplink message via the second type of symbols or the first type of symbols in accordance with the first configuration, or via both the first type of symbols and the second type of symbols in accordance with the second configuration, wherein the one or more repetitions of the uplink message are transmitted based at least in part on transmitting the random access preamble.
Aspect 6: The method of any of aspects 1 through 5, further comprising: receiving a random access message triggering the uplink message; and selecting a first uplink occasion of the one or more uplink occasions of the first set of uplink occasions, the one or more uplink occasions of the second set of uplink occasions, or both based at least in part on a validity of one or more symbols of the first uplink occasion and in accordance with the slot counting procedure, wherein the validity of the one or more symbols is based at least in part on an indication in the random access message, a reference slot type indicated via the second control signaling, a symbol type corresponding to the symbol via which the random access message is received, or any combination thereof.
Aspect 7: The method of any of aspects 1 through 6, further comprising: receiving a random access message triggering the uplink message; and selecting a first uplink occasion of the one or more uplink occasions of the first set of uplink occasions, the one or more uplink occasions of the second set of uplink occasions, or both based at least in part on a validity of one or more symbols of the first uplink occasion and in accordance with the slot counting procedure, the first uplink occasion occurring in a slot that comprises a first subset of the first type of symbols and a second subset of the second type of symbols, wherein the validity of the one or more symbols is based at least in part on a time domain resource allocation in the random access message, a symbol type of a first in time symbol of the slot, a default type of symbol comprising the second type of symbol, or any combination thereof.
Aspect 8: The method of any of aspects 1 through 7, further comprising: receiving a control message indicating a quantity of the one or more repetitions for the uplink message; and selecting the one or more uplink occasions of the first set of uplink occasions, of the second set of uplink occasions, or both according to the slot counting procedure from slots that include the first type of symbols and do not include the second type of symbols in accordance with the control message and the first configuration.
Aspect 9: The method of any of aspects 1 through 8, further comprising: receiving a control message indicating a quantity of the one or more repetitions for the uplink message and a slot offset value indicating a reference slot for a first uplink occasion of the one or more uplink occasions; and selecting the one or more uplink occasions of the first set of uplink occasions, the one or more uplink occasions of the second set of uplink occasions, or both based on a physical slot counting procedure, the first uplink occasion of the one or more uplink occasions of the first set of uplink occasions, the one or more uplink occasions of the second set of uplink occasions, or both located in the reference slot indicated by the slot offset value.
Aspect 10: The method of any of aspects 1 through 9, further comprising: selecting the one or more uplink occasions of the first set of uplink occasions, the one or more uplink occasions of the second set of uplink occasions, or both in accordance with the first configuration and a validity of a plurality of slots; and refraining from selecting one or more additional uplink occasions according to the slot counting procedure in response to the one or more additional uplink occasions comprising the first type of uplink occasion, or in response to a slot comprising an uplink occasion further comprising one or more symbols overlapping in time with a synchronization signal block.
Aspect 11: The method of any of aspects 1 through 10, further comprising: selecting the one or more uplink occasions of the first set of uplink occasions, the one or more uplink occasions of the second set of uplink occasions, or both in accordance with the first configuration and a validity of a plurality of slots; and refraining from selecting one or more additional uplink occasions according to the slot counting procedure in response to the one or more additional uplink occasions comprising the second type of uplink occasion, in response to a slot corresponding to an uplink occasion comprising both the first type of symbol and the second type of symbol, or in response to the slot corresponding to the uplink occasion comprising one or more symbols overlapping in time with a synchronization signal block.
Aspect 12: The method of any of aspects 1 through 11, further comprising: selecting the one or more uplink occasions of the first set of uplink occasions, the one or more uplink occasions of the second set of uplink occasions, or both in accordance with the second configuration and a validity of a plurality of slots according to the slot counting procedure; and refraining from selecting one or more additional uplink occasions according to the slot counting procedure in response to the one or more additional uplink occasions being located within downlink slots, or in response to an uplink occasion being located within a slot that includes both the first type of symbols and the second type of symbols, or in response to the slot corresponding to the uplink occasion comprising one or more symbols overlapping in time with a synchronization signal block.
Aspect 13: The method of any of aspects 1 through 12, wherein receiving the second control signaling comprises: receiving system information comprising a feature combination information element comprising an indication of the first configuration or the second configuration.
Aspect 14: The method of any of aspects 1 through 13, wherein receiving the second control signaling comprises: receiving a random access response message comprising a MAC control element (CE), the MAC-CE indicating the first configuration or the second configuration.
Aspect 15: The method of any of aspects 1 through 14, wherein receiving the second control signaling comprises: receiving a downlink control information message, a field in the downlink control information message comprising an indication of the first configuration or the second configuration.
Aspect 16: The method of any of aspects 1 through 15, further comprising: receiving a downlink control information message triggering transmission of the uplink message, the downlink control information message comprising a frequency hopping offset for repetitions of the uplink message, wherein transmitting the one or more repetitions of the uplink message is in accordance with the frequency hopping offset, and wherein the frequency hopping offset is based at least in part on a subband corresponding to the uplink message and the one or more uplink occasions.
Aspect 17: The method of any of aspects 1 through 16, wherein the one or more repetitions of the uplink message comprise one or more repetitions of a random access message.
Aspect 18: A method for wireless communications at a network entity, comprising: transmitting first control signaling indicating a first set of uplink occasions corresponding to a first type of uplink occasions, and a second set of uplink occasions corresponding to a second type of uplink occasions, wherein the first type of uplink occasions corresponds to a first type of symbols supporting a SBFD mode of operation, and the second type of uplink occasions corresponds to a second type of symbols supporting a half duplex mode of operation; transmitting second control signaling indicating a first configuration or a second configuration, where the first configuration supports wireless communications via the first type of symbols or the second type of symbols, and where the second configuration supports wireless communications via both the first type of symbols and the second type of symbols; and receiving one or more repetitions of an uplink message via one or more uplink occasions of the first set of uplink occasions, via one or more uplink occasions of the second set of uplink occasions, or both, wherein the one or more uplink occasions of the first set of uplink occasions, the one or more uplink occasions of the second set of uplink occasions, or both are based at least in part on a slot counting procedure that is based at least in part on the first configuration or the second configuration.
Aspect 19: The method of aspect 18, wherein transmitting the second control signaling comprises: transmitting a feature combination message indicating support of repetitions of the uplink message, and indicating a first subset of random access resources of a plurality of candidate random access resources, the first subset of random access resources corresponding to the supported repetitions of the uplink message, wherein receiving the one or more repetitions of the uplink message is based at least in part on transmitting the feature combination message.
Aspect 20: The method of aspect 19, wherein the feature combination message indicates that repetition of the uplink message is supported via the first type of symbols or the second type of symbols in accordance with the first configuration.
Aspect 21: The method of any of aspects 19 through 20, wherein the feature combination message indicates that repetitions of the uplink message is supported via both the first type of symbols and the second type of symbols in accordance with the second configuration.
Aspect 22: The method of any of aspects 19 through 21, further comprising: receiving a random access preamble via a random access resource of the first subset of random access resources, the random access preamble received via the random access resource indicating that the UE supports repetitions of the uplink message via the second type of symbols or the first type of symbols in accordance with the first configuration, or via both the first type of symbols and the second type of symbols in accordance with the second configuration, wherein receiving the one or more repetitions of the uplink message is based at least in part on receiving the random access preamble.
Aspect 23: The method of any of aspects 18 through 22, wherein transmitting the second control signaling comprises: transmitting system information comprising a feature combination information element comprising an indication of the first configuration or the second configuration.
Aspect 24: The method of any of aspects 18 through 23, wherein transmitting the second control signaling comprises: transmitting a random access response message comprising a MAC control element (CE), the MAC-CE indicating the first configuration or the second configuration.
Aspect 25: The method of any of aspects 18 through 24, wherein transmitting the second control signaling comprises: transmitting a downlink control information message, a field in the downlink control information message comprising an indication of the first configuration or the second configuration.
Aspect 26: The method of any of aspects 18 through 25, further comprising: transmitting a downlink control information message triggering transmission of the uplink message, the downlink control information message comprising a frequency hopping offset for repetitions of the uplink message, wherein receiving the one or more repetitions of the uplink message is in accordance with the frequency hopping offset, and wherein the frequency hopping offset is based at least in part on a subband corresponding to the uplink message and the one or more uplink occasions.
Aspect 27: The method of any of aspects 18 through 26, wherein the one or more repetitions of the uplink message comprise one or more repetitions of a random access message.
Aspect 28: A UE for wireless communications, comprising one or more memories storing processor-executable code, and one or more processors coupled with the one or more memories and individually or collectively operable to execute the code to cause the UE to perform a method of any of aspects 1 through 17.
Aspect 29: A UE for wireless communications, comprising at least one means for performing a method of any of aspects 1 through 17.
Aspect 30: A non-transitory computer-readable medium storing code for wireless communications, the code comprising instructions executable by one or more processors to perform a method of any of aspects 1 through 17.
Aspect 31: A network entity for wireless communications, comprising one or more memories storing processor-executable code, and one or more processors coupled with the one or more memories and individually or collectively operable to execute the code to cause the network entity to perform a method of any of aspects 18 through 27.
Aspect 32: A network entity for wireless communications, comprising at least one means for performing a method of any of aspects 18 through 27.
Aspect 33: A non-transitory computer-readable medium storing code for wireless communications, the code comprising instructions executable by one or more processors to perform a method of any of aspects 18 through 27.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (such as, a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (such as, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (such as, receiving information), accessing (such as, accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more processors and one or more memories that include instructions stored thereon, the one or more processors when configured cause the apparatus to:
receive first control signaling indicating a first set of uplink occasions corresponding to a first type of uplink occasions, and a second set of uplink occasions corresponding to a second type of uplink occasions, wherein the first type of uplink occasions corresponds to a first type of symbols supporting a subband full duplex mode of operation, and the second type of uplink occasions corresponds to a second type of symbols supporting a half duplex mode of operation;
receive second control signaling indicating a first configuration or a second configuration, wherein the first configuration supports wireless communications via the first type of symbols or the second type of symbols, and wherein the second configuration supports wireless communications via both the first type of symbols and the second type of symbols; and
transmit one or more repetitions of an uplink message via one or more uplink occasions of the first set of uplink occasions, via one or more uplink occasions of the second set of uplink occasions, or both, wherein the one or more uplink occasions of the first set of uplink occasions, the one or more uplink occasions of the second set of uplink occasions, or both are selected in accordance with a slot counting procedure in which one or more slots are counted, wherein the slot counting procedure is based at least in part on the first configuration or the second configuration.

2. The apparatus of claim 1, wherein the one or more processors when configured further cause the apparatus to:
receive a random access message triggering the uplink message; and
select a first uplink occasion of the one or more uplink occasions of the first set of uplink occasions, the one or more uplink occasions of the second set of uplink occasions, or both based at least in part on a validity of one or more symbols of the first uplink occasion and in accordance with the slot counting procedure, wherein the validity of the one or more symbols is based at least in part on an indication in the random access message, a reference slot type indicated via the second control signaling, a symbol type corresponding to a symbol via which the random access message is received, or any combination thereof.

3. The apparatus of claim 1, wherein the one or more processors when configured further cause the apparatus to:
receive a random access message triggering the uplink message; and
select a first uplink occasion of the one or more uplink occasions of the first set of uplink occasions, the one or more uplink occasions of the second set of uplink occasions, or both based at least in part on a validity of one or more symbols of the first uplink occasion and in accordance with the slot counting procedure, the first uplink occasion occurring in a slot that comprises a first subset of the first type of symbols and a second subset of the second type of symbols, wherein the validity of the one or more symbols is based at least in part on a time domain resource allocation in the random access message, a symbol type of a first in time symbol of the slot, a default type of symbol comprising the second type of symbol, or any combination thereof.

4. The apparatus of claim 1, wherein the one or more processors when configured further cause the apparatus to:
select the one or more uplink occasions of the first set of uplink occasions, the one or more uplink occasions of the second set of uplink occasions, or both in accordance with the first configuration and a validity of a plurality of slots; and
refrain from selecting one or more additional uplink occasions according to the slot counting procedure in response to the one or more additional uplink occasions comprising the first type of uplink occasion, or in response to a slot comprising an uplink occasion further comprising one or more symbols overlapping in time with a synchronization signal block.

5. The apparatus of claim 1, wherein the one or more processors when configured further cause the apparatus to:
select the one or more uplink occasions of the first set of uplink occasions, of the second set of uplink occasions, or both in accordance with the first configuration and a validity of a plurality of slots; and
refrain from selecting one or more additional uplink occasions according to the slot counting procedure in response to the one or more additional uplink occasions comprising the second type of uplink occasion, in response to a slot corresponding to an uplink occasion comprising both the first type of symbol and the second type of symbol, or in response to the slot corresponding to the uplink occasion comprising one or more symbols overlapping in time with a synchronization signal block.

6. The apparatus of claim 1, wherein the one or more processors when configured further cause the apparatus to receive a downlink control information message triggering transmission of the uplink message, the downlink control information message comprising a frequency hopping offset for repetitions of the uplink message, wherein the one or more repetitions of the uplink message are transmitted in accordance with the frequency hopping offset, and wherein the frequency hopping offset is based at least in part on a subband corresponding to the uplink message and the one or more uplink occasions of the first set of uplink occasions, the one or more uplink occasions of the second set of uplink occasions, or both.

7. The apparatus of claim 6, wherein the subband corresponding to the uplink message and the one or more uplink occasions of the first set of uplink occasions, the one or more uplink occasions of the second set of uplink occasions, or both corresponds to a quantity of usable uplink physical resource blocks (PRBs), and wherein the frequency hopping offset is based at least in part on the quantity of usable uplink PRBs.

8. The apparatus of claim 1, wherein, to receive the second control signaling, the one or more processors when configured further cause the apparatus to receive a feature combination message indicating support of repetitions of the uplink message, and indicating a first subset of random access resources of a plurality of candidate random access resources, the first subset of random access resources corresponding to the supported repetitions of the uplink message, wherein the one or more repetitions of the uplink message are transmitted based at least in part on receiving the feature combination message.

9. The apparatus of claim 8, wherein the feature combination message indicates that repetition of the uplink message is supported via the first type of symbols or the second type of symbols in accordance with the first configuration.

10. The apparatus of claim 8, wherein the feature combination message indicates that repetitions of the uplink message is supported via both the first type of symbols and the second type of symbols in accordance with the second configuration.

11. The apparatus of claim 8, wherein the one or more processors when configured further cause the apparatus to cause the UE to transmit a random access preamble via a random access resource of the first subset of random access resources, the random access preamble transmitted via the random access resource indicating that the UE supports repetitions of the uplink message via the second type of symbols or the first type of symbols in accordance with the first configuration, or via both the first type of symbols and the second type of symbols in accordance with the second configuration, wherein the one or more repetitions of the uplink message are transmitted based at least in part on transmitting the random access preamble.

12. The apparatus of claim 1, wherein the one or more processors when configured further cause the apparatus to:
receive a control message indicating a quantity of the one or more repetitions for the uplink message; and
select the one or more uplink occasions of the first set of uplink occasions, the one or more uplink occasions of the second set of uplink occasions, or both according to the slot counting procedure from slots that include the first type of symbols and do not include the second type of symbols in accordance with the control message and the first configuration.

13. The apparatus of claim 1, wherein the one or more processors when configured further cause the apparatus to:
receive a control message indicating a quantity of the one or more repetitions for the uplink message and a slot offset value indicating a reference slot for a first uplink occasion of the one or more uplink occasions of the first set of uplink occasions, the one or more uplink occasions of the second set of uplink occasions, or both; and
select the one or more uplink occasions of the first set of uplink occasions, the one or more uplink occasions of the second set of uplink occasions, or both based on a physical slot counting procedure, the first uplink occasion of the one or more uplink occasions of the first set of uplink occasions, the one or more second uplink occasions, or both located in the reference slot indicated by the slot offset value.

14. The apparatus of claim 1, wherein the one or more processors when configured further cause the apparatus to:
select the one or more uplink occasions of the first set of uplink occasions, the one or more uplink occasions of the second set of uplink occasions, or both in accordance with the second configuration and a validity of a plurality of slots according to the slot counting procedure; and
refrain from selecting one or more additional uplink occasions according to the slot counting procedure in response to the one or more additional uplink occasions being located within downlink slots, or in response to an uplink occasion being located within a slot that includes both the first type of symbols and the second type of symbols, or in response to the slot corresponding to the uplink occasion comprising one or more symbols overlapping in time with a synchronization signal block.

15. The apparatus of claim 1, wherein, to receive the second control signaling, the one or more processors when configured further cause the apparatus to cause the UE to receive system information comprising a feature combination information element comprising an indication of the first configuration or the second configuration.

16. An apparatus for wireless communications at a network device, comprising:
one or more processors and one or more memories that include instructions stored thereon, the one or more processors when configured cause the apparatus to:
transmit first control signaling indicating a first set of uplink occasions corresponding to a first type of uplink occasions, and a second set of uplink occasions corresponding to a second type of uplink occasions, wherein the first type of uplink occasions corresponds to a first type of symbols supporting a subband full duplex mode of operation, and the second type of uplink occasions corresponds to a second type of symbols supporting a half duplex mode of operation;
transmit second control signaling indicating a first configuration or a second configuration, wherein the first configuration supports wireless communications via the first type of symbols or the second type of symbols, and wherein the second configuration supports wireless communications via both the first type of symbols and the second type of symbols; and
receive one or more repetitions of an uplink message via one or more uplink occasions of the first set of uplink occasions, via one or more uplink occasions of the second set of uplink occasions, or both, wherein the one or more uplink occasions of the first set of uplink occasions, the one or more uplink occasions of the second set of uplink occasions, or both are based at least in part on a slot counting procedure in which one or more slots are counted, wherein the slot counting procedure is based at least in part on the first configuration or the second configuration.

17. The apparatus of claim 16, wherein the one or more processors when configured further cause the apparatus to transmit a downlink control information message triggering transmission of the uplink message, the downlink control information message comprising a frequency hopping offset for repetitions of the uplink message, wherein receiving the one or more repetitions of the uplink message is in accordance with the frequency hopping offset, and wherein the frequency hopping offset is based at least in part on a subband corresponding to the uplink message and the one or more uplink occasions.

18. The apparatus of claim 16, wherein, to transmit the second control signaling, the one or more processors when configured further cause the apparatus to transmit a feature combination message indicating support of repetitions of the uplink message, and indicating a first subset of random access resources of a plurality of candidate random access resources, the first subset of random access resources corresponding to the supported repetitions of the uplink message, wherein receiving the one or more repetitions of the uplink message is based at least in part on transmitting the feature combination message.

19. The apparatus of claim 18, wherein the feature combination message indicates that repetition of the uplink message is supported via the first type of symbols or the second type of symbols in accordance with the first configuration.

20. A method for wireless communications at a user equipment (UE), comprising:
receiving first control signaling indicating a first set of uplink occasions corresponding to a first type of uplink occasions, and a second set of uplink occasions corresponding to a second type of uplink occasions, wherein the first type of uplink occasions corresponds to a first type of symbols supporting a subband full duplex mode of operation, and the second type of uplink occasions corresponds to a second type of symbols supporting a half duplex mode of operation;
receiving second control signaling indicating a first configuration or a second configuration, wherein the first configuration supports wireless communications via the first type of symbols or the second type of symbols, and wherein the second configuration supports wireless communications via both the first type of symbols and the second type of symbols; and
transmitting one or more repetitions of an uplink message via one or more uplink occasions of the first set of uplink occasions, one or more uplink occasions of the second set of uplink occasions, or both, wherein the one or more uplink occasions of the first set of uplink occasions, the one or more uplink occasions of the second set of uplink occasions, or both are selected in accordance with a slot counting procedure in which one or more slots are counted, where the slot counting procedure is based at least in part on the first configuration or the second configuration.
